(19) United States
(12) Patent Application Publication
(10) Pub. No.: US 2026/0202814 A1
(43) Pub. Date: Jul. 16, 2026

(54) CLOUD-INTEGRATED AUTONOMOUS COMMERCIAL WASTE COMPACTION SYSTEM WITH POP/POS MULTI CYCLE ACCESS CONTROL

(71) Applicant: GOCO CONSTRUCTION WASTE MANAGEMENT, INC., BLUE RIDGE, GA (US)

(72) Inventor: JOSH B GOLDEN, BLUE RIDGE, GA (US)

(73) Assignee: GOCO CONSTRUCTION WASTE MANAGEMENT, INC, BLUE RIDGE, GA (US)

(21) Appl. No.: 19/445,510

(22) Filed: Jan. 10, 2026

Related U.S. Application Data
(60) Provisional application No. 63/745,766, filed on Jan. 15, 2025.

(51) Int. Cl. G05B 19/05; B65F 1/14; G06Q 20/18; G06Q 20/20; G06Q 20/40; G07C 9/00; H04N 23/23

(52) U.S. Cl. CPC G05B 19/058; B65F 1/1405; B65F 1/1421; G06Q 20/18; G06Q 20/208; G06Q 20/401; G07C 9/00309; H04N 23/23

(57) ABSTRACT

An autonomous waste handling system provides POP/POS-controlled access to a waste receiving bin using multi-cycle authorization per approved transaction session. A controller maintains an access door locked until an authorization signal is received, stores an authorized cycle count, unlocks the door, detects a door-open condition followed by a door-closed condition, and increments a usage-cycle counter upon the door-closed condition. The controller re-locks the door when the usage-cycle counter reaches the authorized cycle count or upon receipt of a transaction completion input and stores a transaction record. In some embodiments, thermal sensing analyzes thermal data to declare a hazard when a hotspot metric exceeds a threshold for a defined duration, after which unlocking is inhibited until an authorized reset. In some embodiments, payment processing uses pre-authorization followed by capture at session completion, and pending capture is queued locally during communication outages for later transmission.

### CROSS-REFERENCE

This application claims the benefit of U.S. Provisional Application No. 63/745,766, filed Jan. 15, 2025, entitled “AUTOMATED INVERSE POP/POS SYSTEM FOR A COMMERCIAL TRASH COMPACTOR SYSTEM,” which is incorporated by reference in its entirety.

### FIELD

The present disclosure relates to commercial waste handling and compaction equipment and, more particularly, to an autonomous, cloud-integrated waste compaction system with automated access control enabling unattended public or commercial systems that control user access to a waste receiving bin using POP/POS authorization and multi-cycle usage control.

### BACKGROUND

Commercial waste compactors reduce waste volume prior to hauling, but many deployments require trained operators, controlled access, or separate systems for payment, access control, monitoring, and maintenance. In unattended or semi-public settings, limitations of conventional approaches can include uncontrolled dumping, lack of reliable per-use charging, inability to manage repeat deposits within a single paid session, limited safety monitoring, and reduced visibility into equipment health and usage.

### SUMMARY

Disclosed herein are systems, methods, and non-transitory computer-readable media for operating an autonomous waste handling system that uses POP/POS authorization to grant a user a plurality of access cycles during a single paid session. In some embodiments, a controller (e.g., a PLC) unlocks an access door after receiving an authorization signal, stores an authorized cycle count, tracks completed door cycles, and re-locks the access door when the authorized cycle count is reached or upon early completion.

In some embodiments, the autonomous waste handling system is coupled to, or integrated with, a commercial waste compactor having a compaction chamber and ram actuator, and the controller optionally initiates compaction based on capacity indicators while maintaining required safety interlocks. In some embodiments, the system further includes cloud communication for transaction reporting, diagnostics, configuration, notifications, and optional remote administration

Provided herein is an autonomous commercial waste compaction system comprising: a commercial waste compactor having a compaction chamber, a hydraulic ram actuator, and a detachable receiver box configured to receive compacted waste; a control enclosure housing a programmable logic controller (PLC) configured to execute state-based control logic; a payment kiosk integrated with the control enclosure and comprising at least two payment acceptance devices selected from the group consisting of: credit card readers, debit card readers, near-field communication (NFC) contactless readers, biometric scanners, QR code readers, and token acceptors; a sized receiving bin with an automated access door configured to receive waste materials from users; an electronic door lock actuator electrically connected to the PLC and configured to selectively engage and disengage a locking mechanism securing the automated access door; a door position sensor electrically connected to the PLC and configured to detect open and closed states of the automated access door; a cycle counter implemented in the PLC and configured to increment upon detection of door closure by the door position sensor; a capacity monitoring system comprising at least one sensor selected from the group consisting of: fill level sensors, weight sensors, and hydraulic pressure sensors, said capacity monitoring system configured to detect fill status of the compaction chamber; a multi-protocol communication system comprising at least two communication interfaces selected from the group consisting of: WiFi transceivers, Ethernet interfaces, cellular modems, and radio transceivers, said communication system configured to establish bidirectional communication with remote cloud services via wide area networks; wherein the PLC

executes state-based control logic to: (i) maintain the electronic door lock actuator in an engaged state preventing door opening until receiving a payment authorization signal from the payment kiosk; (ii) responsive to receiving the payment authorization signal, command the electronic door lock actuator to disengage the locking mechanism and store an authorized cycle count value in PLC memory; (iii) monitor the door position sensor and responsive to detecting door closing, increment the cycle counter; (iv) compare a value of the cycle counter to the authorized cycle count value and responsive to the cycle counter value reaching the authorized cycle count value, command the electronic door lock actuator to re-engage the locking mechanism; (v) monitor the capacity monitoring system and responsive to detecting that fill status exceeds a compaction trigger threshold, activate the hydraulic ram actuator to perform a compaction cycle; and (vi) transmit operational data to the remote cloud services via the multi-protocol communication system, said operational data comprising transaction records, cycle counts, fill status measurements, and system diagnostic information.

In some embodiments, the payment kiosk further comprises: a payment processor configured to communicate with financial networks for real-time transaction authorization; and wherein receiving the payment authorization signal comprises the payment processor receiving authorization confirmation from a financial network authorizing a payment transaction.

In some embodiments, the sized receiving bin further comprises a weight sensor integrated into a door mounting mechanism of the automated access door and configured to measure weight of waste materials deposited into the sized receiving bin; wherein the PLC is further configured to read weight measurements from the weight sensor upon detecting door closing and store the weight measurements with transaction records.

In some embodiments, the PLC is further configured to calculate a transaction cost based on total weight measured across multiple door open/close cycles within a single transaction; and transmit payment charging instructions to the payment kiosk based on the calculated transaction cost.

In some embodiments, the system further comprises an infrared thermal imaging camera positioned with a field of view encompassing an interior of the sized receiving bin; wherein the PLC is configured to: receive thermal image data from the infrared thermal imaging camera; analyze the thermal image data to detect thermal signatures exceeding a temperature threshold; and responsive to detecting thermal signatures exceeding the temperature threshold, generate a hazardous material alert transmitted to the remote cloud services.

In some embodiments, the PLC is further configured to be responsive to detecting thermal signatures exceeding the temperature threshold, prevent subsequent unlocking of the electronic door lock until manual reset by authorized personnel.

In some embodiments, the capacity monitoring system comprises a plurality of fill level sensors positioned at different vertical heights within the compaction chamber; wherein monitoring fill status comprises the PLC determining which fill level sensors detect presence of waste material to calculate a percentage fill level.

In some embodiments, the state-based control logic executed by the PLC defines discrete operational states comprising a standby state with the locking mechanism engaged; a payment authorization state awaiting payment authorization signal; an access granted state with the locking mechanism disengaged; a door open state; a cycle evaluation state following door closing; a transaction completion state processing final payment; and a compaction cycle state with the hydraulic ram actuator activated; wherein the PLC transitions between operational states based on events detected by sensors electrically connected to the PLC.

In some embodiments, the system further comprises a multi-source power management system comprising input terminals for grid power connection; battery charge management circuitry electrically connected to a battery bank; solar charge controller inputs configured to receive power from photovoltaic panels; automatic transfer switching circuitry configured to transition between power sources without interrupting operation of the PLC; and uninterruptible power supply (UPS) circuitry providing continuous power to the PLC during power source transitions.

In some embodiments, the multi-source power management system is configured to prioritize grid power when available; charge the battery bank using solar power during daylight hours when photovoltaic panels generate sufficient power; supply power to the PLC from the battery bank when grid power is unavailable and solar power is insufficient; and wherein the system is capable of autonomous operation 24 hours per day, 7 days per week, 365 days per year without external power infrastructure.

In some embodiments, the PLC is further configured to execute diagnostic routines comprising polling each sensor electrically connected to the PLC to verify sensor responsiveness; commanding each actuator electrically connected to the PLC to a test state and verifying state change via sensors; verifying communication link connectivity to the remote cloud services; generating a diagnostic report summarizing results of the diagnostic routines; and transmitting the diagnostic report to the remote cloud services.

In some embodiments, the PLC is configured to execute the diagnostic routines following completion of each user transaction; and periodically at predetermined time intervals during idle periods; wherein the diagnostic report includes timestamps, sensor readings, fault flags, and pass/fail status for each subsystem.

In some embodiments, the remote cloud services comprise a data storage system storing transaction records, sensor data logs, and diagnostic reports uploaded from the PLC; an analytics processing system configured to analyze stored data and generate operational metrics, capacity predictions, and maintenance recommendations; a notification generation system configured to generate notifications transmitted to operator devices based on predefined trigger conditions; and a web application accessible via web browsers providing user interfaces for monitoring system status, viewing analytics, and configuring system parameters.

In some embodiments, the notification generation system is configured to compare fill status measurements to a service dispatch threshold; responsive to fill status exceeding the service dispatch threshold, generate a service dispatch notification transmitted to waste hauling service providers, said notification including GPS location coordinates and estimated time until full capacity.

In some embodiments, the commercial waste compactor is selected from the group consisting of a stationary compactor with the detachable receiver box configured for periodic removal and replacement; a self-contained mobile compactor system with integrated wheels or tracks; a mobile compactor trailer configured for towing by a vehicle; and a compactor integrated with a truck chassis.

Provided herein is a integrated control cabinet for an automated waste compactor system comprising: a weather-resistant enclosure configured for outdoor mounting adjacent to a commercial waste compactor; a programmable logic controller (PLC) housed within the enclosure; a human-machine interface (HMI) touchscreen mounted on an exterior surface of the enclosure and electrically connected to the PLC; a payment processing module integrated into the enclosure and comprising: a payment terminal with a card reader and NFC contactless reader; a payment processor configured to communicate with financial networks for real-time transaction authorization; and a receipt printer; a sensor interface module electrically connected to the PLC and configured to receive inputs from: at least one video camera; at least one thermal imaging camera configured to detect elevated temperature signatures; at least one weight sensor; at least one hydraulic pressure sensor; at least one fill level sensor selected from the group consisting of ultrasonic distance sensors, laser rangefinders, and mechanical limit switches; at least one door position sensor; and at least one tamper detection sensor selected from the group consisting of vibration sensors and accelerometers; an actuator control module electrically connected to the PLC and configured to control: at least one electronic door lock actuator; at least one hydraulic motor controller for actuating a compactor ram; indicator lights; and audible alarm devices; a multi-source power management system comprising: input terminals for grid power connection; battery charge management circuitry; solar charge controller inputs; automatic transfer switching configured to transition between power sources without interrupting PLC operation; and uninterruptible power supply (UPS) circuitry providing ride-through power during power source transitions; a communication system comprising at least two interfaces selected from the group consisting of: a WiFi radio; an Ethernet port; a cellular modem; and a long-range radio transceiver; wherein the PLC is configured to coordinate operations between the HMI, payment processing module, sensor interface module, actuator control module, and communication system to enable autonomous waste compactor operation and transmit real-time operational data to cloud services via the communication system.

In some embodiments, the integrated control cabinet enclosure further houses: operator control interfaces comprising: owner/operator override controls enabling manual system control by authorized personnel; emergency stop controls configured to immediately halt all system operations; and manual movement controls configured to actuate compactor mechanisms for maintenance purposes.

In some embodiments, the at least one thermal imaging camera comprises: a first thermal imaging camera with a field of view encompassing a waste receiving bin interior for detecting hazardous materials; and a second thermal imaging camera with a field of view encompassing a compaction chamber interior for detecting fire conditions.

In some embodiments, the PLC comprises: a first processor executing control logic for payment authorization and user access control; a second processor executing control logic for sensor monitoring and data logging; a third processor executing control logic for compactor mechanism control and safety interlocks; wherein the first, second, and third processors communicate via an internal communication bus and coordinate operations to enable autonomous waste compactor operation.

Provided herein is a method of autonomously operating a commercial waste compaction system comprising: providing a commercial waste compactor having a compaction chamber and a hydraulic ram; integrating a control system with the waste compactor, said control system comprising: a payment authorization device, an electronic door lock actuator controlling access to a receiving bin, a programmable logic controller (PLC), and a communication system configured to transmit data to remote cloud servers; initializing the PLC to a standby state with the electronic door lock actuator maintaining a door lock in an engaged state; receiving, by the PLC, a payment authorization signal from the payment authorization device indicating successful payment authorization; responsive to receiving the payment authorization signal: commanding, by the PLC, the electronic door lock actuator to disengage the door lock; storing, by the PLC, an authorized cycle count in PLC memory based on payment amount or payment type; initializing, by the PLC, a usage cycle counter to zero; monitoring, by the PLC, a door position sensor; detecting, by the PLC, door opening followed by door closing based on signals from the door position sensor; incrementing, by the PLC, the usage cycle counter upon detecting door closing; comparing, by the PLC, the usage cycle counter to the authorized cycle count; if the usage cycle counter is less than the authorized cycle count and a transaction completion signal has not been received: maintaining, by the PLC, the door lock in a disengaged state to permit additional disposal cycles; if the usage cycle counter equals the authorized cycle count or a transaction completion signal is received: commanding, by the PLC, the electronic door lock actuator to engage the door lock; processing, by the PLC, a final payment transaction; executing, by the PLC, diagnostic routines to verify operational status; and transmitting, by the communication system, transaction data and diagnostic data to the remote cloud servers; monitoring, by the PLC, fill level sensors in the compaction chamber independently of user transaction status; responsive to detecting that fill level exceeds a compaction trigger threshold, activating, by the PLC, the hydraulic ram to perform a compaction cycle; and returning to the standby state with the door lock engaged.

In some embodiments, the method further comprises reading, by the PLC, weight measurements from a weight sensor integrated into the receiving bin upon detecting each door closing event; accumulating, by the PLC, total weight deposited across multiple disposal cycles within a single transaction; calculating, by the PLC, a transaction cost based on the accumulated total weight and a per-unit-weight pricing rate; and processing the final payment transaction based on the calculated transaction cost.

In some embodiments, the method further comprises receiving, by the PLC, thermal image data from an infrared thermal imaging camera positioned to view contents of the receiving bin; analyzing, by the PLC, the thermal image data to identify thermal signatures exceeding a temperature threshold indicating potential hazardous materials or fire hazards; responsive to identifying thermal signatures exceeding the temperature threshold: generating, by the PLC, a hazardous material alert; transmitting, by the communication system, the hazardous material alert to the remote cloud servers; and preventing, by the PLC, subsequent door unlocking until manual reset by authorized personnel.

In some embodiments of the method, executing diagnostic routines comprises polling, by the PLC, each sensor connected to the PLC to verify sensor responsiveness; commanding, by the PLC, each actuator connected to the PLC to a test state and verifying state change via sensors; checking, by the PLC, communication link status by transmitting a heartbeat message to the remote cloud servers and awaiting acknowledgment; monitoring, by the PLC, power supply voltage levels; generating, by the PLC, a diagnostic report comprising pass/fail status for each subsystem, sensor readings, fault flags, and timestamp; and transmitting, by the communication system, the diagnostic report to the remote cloud servers.

In some embodiments, the method enables autonomous operation of the waste compaction system 24 hours per day, 7 days per week, 365 days per year without requiring on-site human operators.

In some embodiments of the method, activating the hydraulic ram to perform a compaction cycle comprises commanding, by the PLC, a hydraulic motor controller to activate a hydraulic pump; extending, by hydraulic pressure, the hydraulic ram into the compaction chamber to compress accumulated waste; monitoring, by the PLC, hydraulic pressure sensors to detect compaction completion when pressure exceeds a completion threshold; commanding, by the PLC, the hydraulic motor controller to retract the hydraulic ram to a home position; re-evaluating, by the PLC, the fill level sensors to determine updated fill status; if updated fill status is below the compaction trigger threshold, re-enabling, by the PLC, customer access functionality; and if updated fill status remains above a receiver box full threshold: entering, by the PLC, an out-of-service state; displaying, by a user interface, a message indicating the system is unavailable; transmitting, by the communication system, a service dispatch notification to the remote cloud servers; and maintaining the door lock in the engaged state until service personnel empty a receiver box and reset the system.

Provided herein is a non-transitory computer-readable storage media encoded with instructions executable by a programmable logic controller (PLC) to operate an autonomous waste compaction system, the instructions comprising instructions to maintain a door lock actuator in an engaged state and monitor for payment authorization signals from a payment device; instructions to, responsive to receiving a payment authorization signal: command the door lock actuator to disengage a door lock; store an authorized cycle count value in memory; initialize a usage cycle counter to zero; instructions to monitor a door position sensor and detect door state transitions between open and closed states; instructions to, responsive to detecting a door closing event: increment the usage cycle counter; compare the usage cycle counter to the authorized cycle count value; if the usage cycle counter is less than the authorized cycle count value, maintain the door lock actuator in a disengaged state; if the usage cycle counter equals or exceeds the authorized cycle count value, command the door lock actuator to engage the door lock; instructions to monitor fill level sensors and hydraulic pressure sensors to determine compaction chamber fill status; instructions to, responsive to determining that fill status exceeds a compaction trigger threshold: disable door unlock functionality; activate a hydraulic motor controller to extend a compactor ram into a compaction chamber; monitor ram position and hydraulic pressure to detect compaction completion; upon detecting compaction completion, command retraction of the compactor ram; re-evaluate fill status; instructions to capture and store transaction records comprising timestamps, cycle counts, weight measurements, and user identifiers; instructions to execute diagnostic routines comprising: polling sensor responsiveness; verifying actuator functionality; checking communication link status; and generating diagnostic reports; and instructions to transmit operational data including the transaction records, diagnostic reports, and sensor data to remote cloud servers via a communication interface.

In some embodiments, the storage media instructions further comprise: instructions to implement a state machine control algorithm defining operational states comprising: a standby state; a payment authorization state; an access granted state; a door open state; a cycle evaluation state; a transaction completion state; a compaction cycle state; and a diagnostic state; and defining state transitions based on events detected by sensors electrically connected to the PLC.

In some embodiments of the storage media, the instructions to execute diagnostic routines further comprise instructions to compare sensor readings to expected value ranges and flag sensors providing readings outside expected ranges; instructions to compare actuator response times to expected response time ranges and flag actuators with response times outside expected ranges; instructions to track cumulative cycle counts for actuators and flag actuators approaching maintenance cycle thresholds; instructions to analyze hydraulic pressure patterns over time and flag anomalies indicating hydraulic system degradation; and instructions to generate predictive maintenance recommendations based on flagged components and transmit the recommendations to the remote cloud servers.

In some embodiments, the instructions further comprise instructions to receive configuration data from the remote cloud servers, said configuration data comprising: pricing parameters defining cost per cycle, cost per unit weight, or tiered pricing structures; authorized cycle count values corresponding to different payment amounts; compaction trigger threshold values; diagnostic routine execution frequency; notification trigger conditions and notification recipient addresses; instructions to store the configuration data in non-volatile memory; and instructions to apply the configuration data to operational logic without requiring firmware updates or system restarts.

Additional aspects and advantages of the present disclosure will become readily apparent to those skilled in this art from the following detailed description, wherein only exemplary embodiments of the present disclosure are shown and described, simply by way of illustration of the several modes or best mode contemplated for carrying out the present disclosure. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the system are set forth with particularity in the appended claims. A better understanding of the features and advantages of the present system will be obtained by reference to the following detailed description that sets forth illustrative embodiments, in which the principles of the system are utilized, and the accompanying drawings of which:

FIG. 1-A is a perspective view of an interactive, automated-access commercial trash compactor system showing the integrated control cabinet, payment kiosk, and compactor housing;

FIG. 1-B is a simplified schematic cross-sectional view of a commercial trash compactor compaction chamber showing the ram/platen, receiving chamber, and discharge door;

FIG. 2 is a front perspective view of a point-of-pay (POP) digital payment system kiosk showing the sized receiving bin, automated access door, display screen, keyboard panel, activation buttons, and payment collection devices;

FIG. 3 is a side perspective view of the POP digital payment system kiosk showing the open receiving bin in greater detail;

FIG. 4 is a detailed view of the payment kiosk interface components including the digital screen display, keyboard/display panel, activation and deactivation buttons, and payment collection device with NFC/contactless readers;

FIG. 5 is a front elevation view of the POP digital payment system kiosk showing dimensional relationships and component placement;

FIG. 6 is a cross-sectional view of the POP digital payment kiosk and sized receiving bin assembly in the closed position, showing the automated access door, roller bearings, weight scales, and internal volume;

FIG. 7 is a representative front view illustration of the interactive, automated-access POP system showing the payment kiosk with sized receiving bin and automated access door;

FIG. 8 is an isometric view of the POP system showing the three-dimensional relationship of the payment kiosk, receiving bin, and access door;

FIG. 9 is a cross-sectional view of the POP digital payment kiosk showing internal mechanisms for door actuation and bin positioning;

FIG. 10 is a cross-sectional view of the POP digital payment kiosk and sized receiving bin assembly in the open position, showing the automated access door in the open configuration;

FIG. 11 is a system architecture diagram showing the cloud-integrated autonomous waste compaction system composition including local hardware, communication pathways, and cloud services;

FIG. 12 is a detailed block diagram of the cloud services interface showing API services, data logging, notifications, analytics dashboards, payment processing services, and video feed transmission;

FIG. 13 is a detailed flow diagram of the cabinet control subsystems showing PLCs, HMI, sensors, actuators, contactors, relays, and operator override functions;

FIG. 14 is a state-based flow diagram showing machine internal systems control logic for normal operations including standby, payment authorization, door control, cycle counting, capacity evaluation, compaction actuation, and diagnostic routines;

FIG. 15 is a software flow diagram illustrating the maintenance operations use case showing operator access, diagnostic functions, manual controls, and override capabilities;

FIG. 16 is a software flow diagram illustrating the administrator operations use case via cloud application showing remote monitoring, configuration management, analytics access, and system control;

FIG. 17 is a software flow diagram illustrating the customer transaction use case showing the sequence from payment presentation through authorization, door unlock, waste deposition cycles, cost calculation, transaction completion, payment processing, and diagnostics;

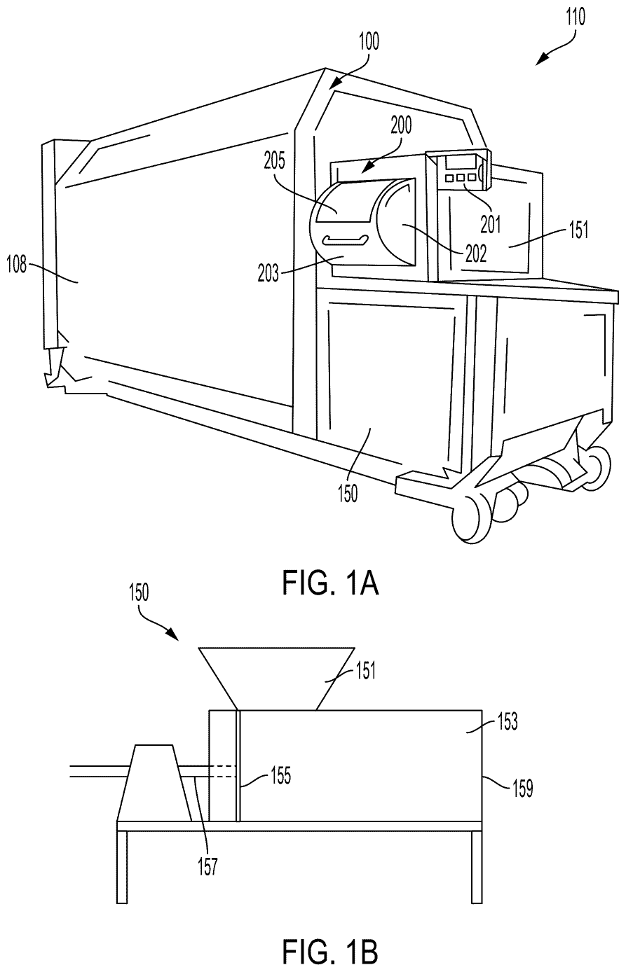

FIGS. 1A-1B illustrate example installations including stationary compactors with detachable receiver boxes and mobile compactor platforms.

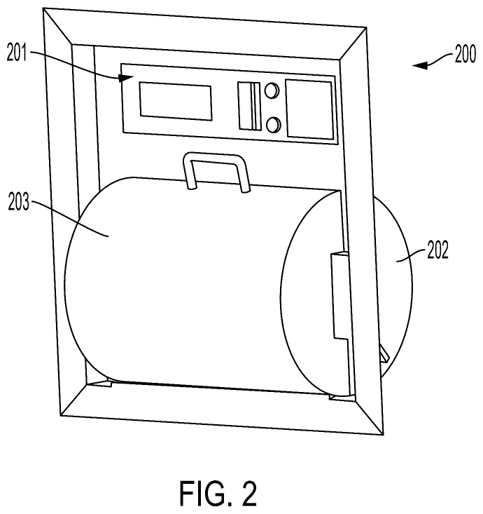

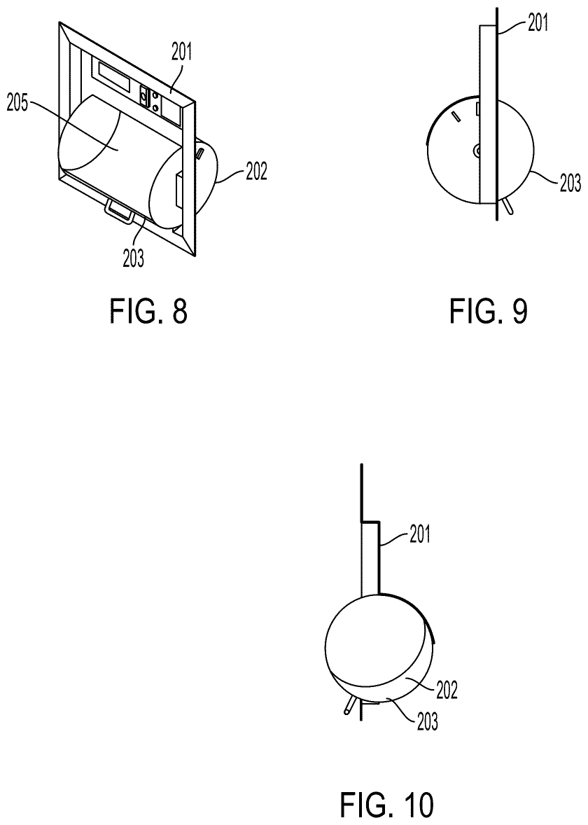

FIGS. 2-10 illustrate an example POP/POS kiosk with a receiving bin and an access door.

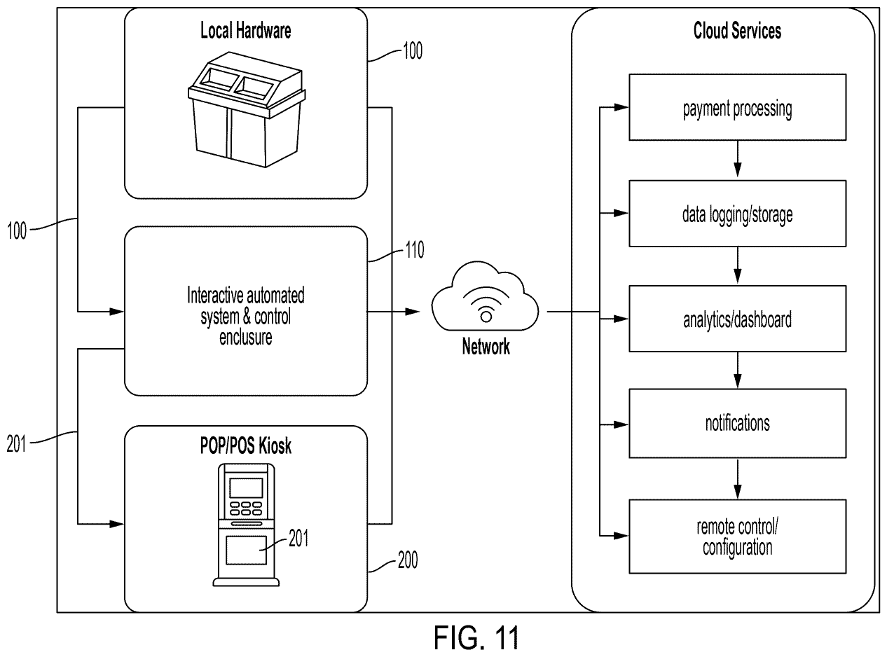

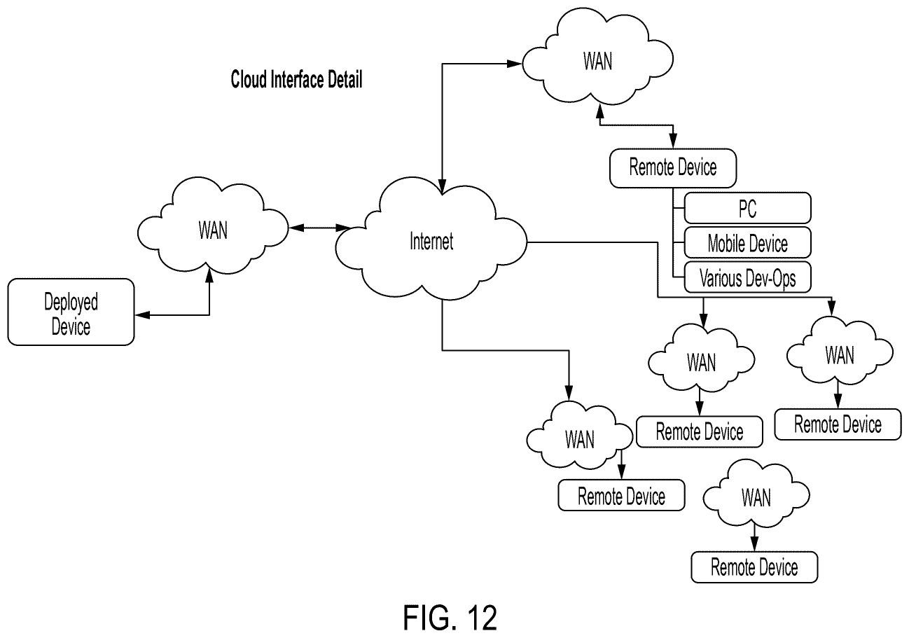

FIGS. 11-12 illustrate example system/cloud architectures and example cloud services interfaces.

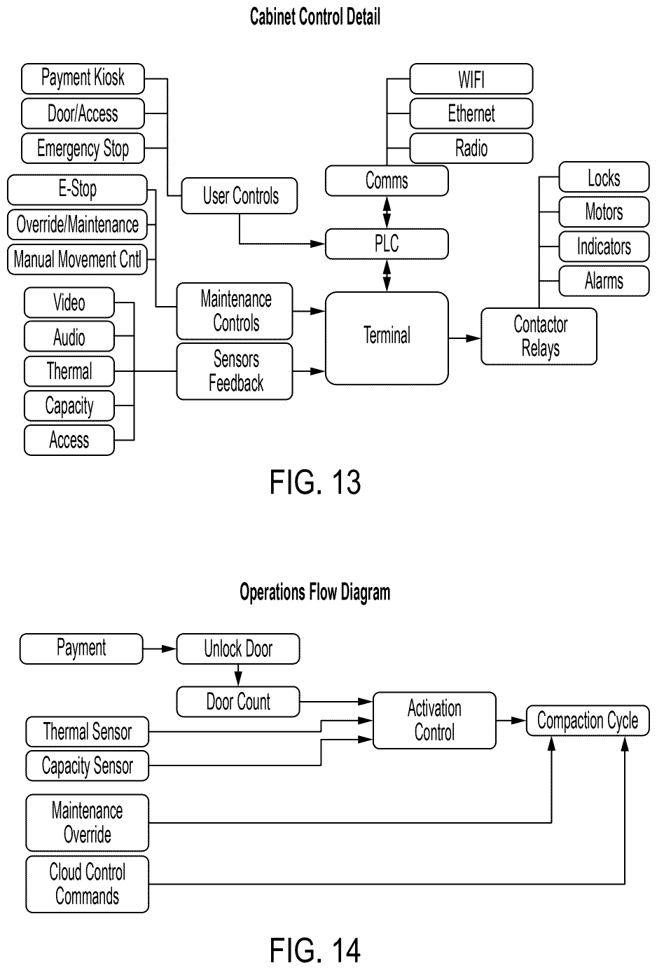

FIGS. 13-17 illustrate example control cabinet subsystems, example state-based control logic, maintenance/admin workflows, and a customer transaction workflow.

The foregoing and other features of the present disclosure will become apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

### DETAILED DESCRIPTION

While preferred embodiments of the present system have been shown and described herein, it will be obvious to those skilled in the art that such embodiments are provided by way of example only. Numerous variations, changes, and substitutions will now occur to those skilled in the art without departing from the system. It should be understood that various alternatives to the embodiments of the system described herein may be employed in practicing the system.

### Definitions

Reference throughout the disclosure to “an exemplary embodiment,” “an embodiment,” or variations thereof means that a particular feature, structure, or characteristic described in connection with an embodiment is included in at least one embodiment of the subject matter disclosed. Thus, the appearance of the phrases “in an exemplary embodiment,” “in an embodiment,” or variations thereof in various places throughout the disclosure is not necessarily referring to the same embodiment. Further, the particular features, structures or characteristics may be combined in any suitable manner in one or more embodiments.

As used herein, and unless otherwise specified, the term “autonomous operation” refers to operation of the waste compaction system without requiring on-site human operators, where all essential functions including payment authorization, access control, waste acceptance, compaction actuation, capacity monitoring, and diagnostic reporting are performed automatically by integrated control systems.

As used herein, and unless otherwise specified, the term “cycle” refers to a single opening and closing sequence of the automated access door, permitting a user to deposit waste material into the receiving bin once per cycle.

As used herein, “authorized cycle count” is a stored value defining a maximum number of cycles permitted during a transaction session before re-locking, unless early completion occurs.

As used herein, “POP/POS” refers to a point-of-payment/point-of-sale interface that accepts user payment credentials or account credentials and produces an authorization result. As used herein, a “transaction session” begins when an authorization signal is received for a user and ends when the door is re-locked after completion criteria are met.

As used herein, and unless otherwise specified, the term “state-based control logic” or “state machine control” refers to a control algorithm wherein the system operates in distinct operational states (such as standby, authorized access, door open, evaluating capacity, compacting, etc.) and transitions between states based on specific events or conditions detected by sensors or timers.

As used herein, and unless otherwise specified, the term “cloud services” refers to remote server infrastructure accessible via wide area networks (such as the Internet) providing data storage, analytics processing, user interfaces via web applications or mobile applications, and API services for system integration.

As used herein, and unless otherwise specified, the term “PLC” refers to a programmable logic controller, which is a ruggedized industrial computer designed for control of manufacturing processes, machinery, or electromechanical systems through digital or analog inputs and outputs.

As used herein, the terms “comprises”, “comprising”, or any other variation thereof, are intended to cover a nonexclusive inclusion, such that a process, method, article, or apparatus that comprises a list of elements does not include only those elements but may include other elements not expressly listed or inherent to such process, method, article, or apparatus. As used herein, and unless otherwise specified, the term “about” or “approximately” means

the system or device further comprises an acceptable error for a particular value as determined by one of ordinary skill in the art, which depends in part on how the value is measured or determined. In certain embodiments, the term “about” or “approximately” means within 1, 2, 3, or 4 standard deviations. In certain embodiments, the term “about” or “approximately” means within 30%, 25%, 20%, 15%, 10%, 9%, 8%, 7%, 6%, 5%, 4%, 3%, 2%, 1%, 0.5%, 0.1%, or 0.05% of a given value or range. In certain embodiments, the term “about” or “approximately” means within 40.0 mm, 30.0 mm, 20.0 mm, 10.0 mm 5.0 mm 1.0 mm, 0.9 mm, 0.8 mm, 0.7 mm, 0.6 mm, 0.5 mm, 0.4 mm, 0.3 mm, 0.2 mm or 0.1 mm of a given value or range. In certain embodiments, the term “about” or “approximately” means within 5.0 kg, 2.5 kg, 1.0 kg, 0.9 kg, 0.8 kg, 0.7 kg, 0.6 kg, 0.5 kg, 0.4 kg, 0.3 kg, 0.2 kg or 0.1 kg of a given value or range, including increments therein. In certain embodiments, the term “about” or “approximately” means within 1 hour, within 45

minutes, within 30 minutes, within 25 minutes, within 20 minutes, within 15 minutes, within 10 minutes, within 5 minutes, within 4 minutes, within 3 minutes, within 2 minutes, or within 1 minute. In certain embodiments, the term “about” or “approximately” means within 20.0 degrees, 15.0 degrees, 10.0 degrees, 9.0 degrees, 8.0 degrees, 7.0 degrees, 6.0 degrees, 5.0 degrees, 4.0 degrees, 3.0 degrees, 2.0 degrees, 1.0 degrees, 0.9 degrees, 0.8 degrees, 0.7 degrees, 0.6 degrees, 0.5 degrees, 0.4 degrees, 0.3 degrees, 0.2 degrees, 0.1 degrees, 0.09 degrees. 0.08 degrees, 0.07 degrees, 0.06 degrees, 0.05 degrees, 0.04 degrees, 0.03 degrees, 0.02 degrees or 0.01 degrees of a given value or range, including increments therein.

As used herein, and unless otherwise specified, the term “substantially”, or “substantially equal” means within 1 or 2 standard deviations. In certain embodiments, the term “substantially”, or “substantially equal” means within 5%, 4%, 3%, 2%, 1%, 0.5%, 0.1%, or 0.05% of a given value or range. In certain embodiments, the term “substantially”, or “substantially equal” means within 1.0 mm, 0.9 mm, 0.8 mm, 0.7 mm, 0.6 mm, 0.5 mm, 0.4 mm, 0.3 mm, 0.2 mm or 0.1 mm of a given value or range. In certain embodiments, the term “substantially”, or “substantially equal” means within 1.0 kg, 0.9 kg, 0.8 kg, 0.7 kg, 0.6 kg, 0.5 kg, 0.4 kg, 0.3 kg, 0.2 kg or 0.1 kg of a given value or range, including increments therein. In certain embodiments, the term “substantially”, or “substantially equal” means within 2 minutes, or within 1 minute. In certain embodiments, the term “substantially”, or “substantially equal” means within 5.0 degrees, 4.0 degrees, 3.0 degrees, 2.0 degrees, 1.0 degrees, 0.9 degrees, 0.8 degrees, 0.7 degrees, 0.6 degrees, 0.5 degrees, 0.4 degrees, 0.3 degrees, 0.2 degrees, 0.1 degrees, 0.09 degrees. 0.08 degrees, 0.07 degrees, 0.06 degrees, 0.05 degrees, 0.04 degrees, 0.03 degrees, 0.02 degrees or 0.01 degrees of a given value or range, including increments therein.

As used herein, and unless otherwise specified, the term “plurality”, and like terms, refers to a number (of things) comprising at least one (thing), or greater than one (thing), as in “two or more” (things), “three or more” (things), “four or more” (things), etc.

As used herein, the terms “connected”, “operationally connected”, “coupled”, “operationally coupled”, “operationally linked”, “operably connected”, “operably coupled”, “operably linked,” and like terms, refer to a relationship (mechanical, linkage, coupling, etc.) between elements whereby operation of one element results in a corresponding, following, or simultaneous operation or actuation of a second element. It is noted that in using said terms to describe inventive embodiments, specific structures or mechanisms that link or couple the elements are typically described. However, unless otherwise specifically stated, when one of said terms is used, the term indicates that the actual linkage or coupling may take a variety of forms, which in certain instances will be readily apparent to a person of ordinary skill in the relevant technology.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

As used herein, the term “proximity” means nearness in space or relationship but not excluding the potential to be touching. Proximity is also alternatively meant to mean that one thing may be so close to another thing as to be “in direct or nearly direct contact” (in

proximity) with another thing along some point. To “place something in proximity” is also meant to mean that items are “paired” or “mated together” either in their paired function or at some point of contact.

As used herein, and unless otherwise specified, the term “vertically oriented” and similar terms mean; generally perpendicular to, at, or near, right angles to a horizontal plane; in a direction or having an alignment such that the top of a thing is above the bottom. In certain embodiments, the term “vertically oriented” means within ±20.0 degrees, ±15.0 degrees, ±10.0 degrees, ±9.0 degrees, ±8.0 degrees, ±7.0 degrees, ±6.0 degrees, ±5.0 degrees, ±4.0 degrees, ±3.0 degrees, ±2.0 degrees, ±1.0 degrees, ±0.9 degrees, ±0.8 degrees, ±0.7 degrees, ±0.6 degrees, ±0.5 degrees, ±0.4 degrees, ±0.3 degrees, ±0.2 degrees or ±0.1 degrees of a given value or range, including increments therein.

As used herein, and unless otherwise specified, the term “horizontally oriented” and similar terms mean; generally perpendicular to, at, or near, right angles to a vertical plane; in a direction or having an alignment such that the top of a thing is generally on, or near the same plane as the bottom, both being parallel or near parallel to the horizon. In certain embodiments, the term “horizontally oriented” means within ±20.0 degrees, ±15.0 degrees, ±10.0 degrees, ±9.0 degrees, ±8.0 degrees, ±7.0 degrees, ±6.0 degrees, ±5.0 degrees, ±4.0 degrees, ±3.0 degrees, ±2.0 degrees, ±1.0 degrees, ±0.9 degrees, ±0.8 degrees, ±0.7 degrees, ±0.6 degrees, ±0.5 degrees, ±0.4 degrees, ±0.3 degrees, ±0.2 degrees or ±0.1 degrees of a given value or range, including increments therein.

As used herein, and unless otherwise specified, the term “substantially perpendicular” and similar terms mean generally at or near 90 degrees to a given line, or surface or to the ground. In certain embodiments, the term “substantially perpendicular” means within ±20.0 degrees, ±15.0 degrees, ±10.0 degrees, ±9.0 degrees, ±8.0 degrees, ±7.0 degrees, ±6.0 degrees, ±5.0 degrees, ±4.0 degrees, ±3.0 degrees, ±2.0 degrees, ±1.0 degrees, ±0.9 degrees, ±0.8 degrees, ±0.7 degrees, ±0.6 degrees, ±0.5 degrees, ±0.4 degrees, ±0.3 degrees, ±0.2 degrees or ±0.1 degrees of a given value or range, including increments therein.

As used herein, and unless otherwise specified, combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C.

### Description of Related Art

Commercial waste compaction is widely used to reduce waste volume before transport to disposal facilities. Traditional commercial compactors require manual operation by trained personnel or are deployed in secured locations accessible only to authorized users with physical keys or access codes. These systems lack integration with payment processing, cannot operate autonomously without on-site staff, and provide limited operational monitoring.

Some prior art systems have attempted to address aspects of waste collection with payment or access control. For example, US 2014/0286743 A1 (hereinafter “the '743 publication”) discloses a user-pay waste container with a locked door that unlocks upon payment, allowing users to deposit waste after paying a tariff. However, the '743 publication fails to disclose or suggest: (i) cycle-based access control where a single payment entitles the user to multiple disposal cycles; (ii) integration with compaction equipment where accumulated waste is compressed after multiple disposal cycles; (iii) cloud-based monitoring and control systems enabling remote operation; (iv) state machine control logic coordinating payment, door control, cycle counting, and compaction actuation; or (v) sensor arrays for detecting fill levels, hazardous materials, and equipment health.

Other prior art systems provide incentive-based recycling with rewards for depositing recyclable materials. U.S. Pat. No. 10,354,474 B2 (hereinafter “the '474 patent”) describes systems where users earn credits based on the quantity of waste recycled, with credits redeemable for monetary value or vouchers. However, the '474 patent addresses the inverse transaction flow (paying users for recyclables) rather than charging users for general waste disposal, and fails to disclose integration with commercial compaction equipment, autonomous 24/7 operation, or comprehensive cloud-based system monitoring.

Automated compaction systems exist in the prior art, such as U.S. Pat. No. 4,953,109 (hereinafter “the '109 patent”), which describes automated trash compaction with hydraulic controls and sensors that monitor fullness levels. However, the '109 patent is directed to the compaction mechanism itself and fails to disclose or suggest: (i) integration with payment authorization systems; (ii) electronically controlled access systems that gate user access based on payment verification; (iii) cycle-based operational logic; or (iv) cloud connectivity for remote monitoring and control.

Thus, there exists a long-felt but unmet need for a fully autonomous commercial waste compaction system that integrates: (a) payment authorization systems enabling public or commercial access; (b) electronically controlled access mechanisms with cycle-based usage tracking; (c) automated compaction control based on fill level monitoring; (d) comprehensive sensor arrays for safety, security, and operational monitoring; and (e) cloud-integrated remote monitoring, diagnostics, and control capabilities, all coordinated through integrated control logic enabling unattended operation 24 hours per day, 7 days per week, 365 days per year.

### System Overview

FIG. 1A and FIG. 11 illustrate the overall system architecture of the cloud-integrated autonomous waste compaction system 100. The system comprises a commercial trash compactor 100, an interactive, automated commercial trash compactor system 110 integrated with the commercial compactor, and a cloud services infrastructure accessible via wide area network communications.

The commercial trash compactor 100 may be configured in various embodiments including: (i) a stationary compactor 120 with an affixed receiver box 108 as shown in FIG. 1-A.

Alternative embodiments (not shown, but described herein) may include the commercial trash compactor 100 configured in various embodiments including: (i) a stationary compactor with a detachable, transportable receiver box 108; (ii) a self-contained, mobile compactor system; (iii) a mobile, self-contained compactor; (iv) a self-contained mobile compactor trailer; or (v) a typical compactor garbage truck. All of the described alternative embodiments are known in the commercial trash collection and compactor industry; however none are known to include the point-of-pay (POP) or point-of-sale (POS) digital payment system 200 integrated with the commercial waste compactor, as described herein.

Each described embodiment/configuration includes a compactor platen/ram subsystem 150 comprising a waste hopper/chute 151, a receiving chamber/compaction chamber or charge box 153, a compaction plate/platen or ram 155, a power screw or hydraulic piston 157 for actuating the ram, and a discharge door 159 for the compaction chamber, as illustrated in FIG. 1-B. The compactor system receiver box 108 is positioned to receive compacted waste from the discharge door 159.

### Mechanical Subsystem (Point-of-Pay Digital Payment System)

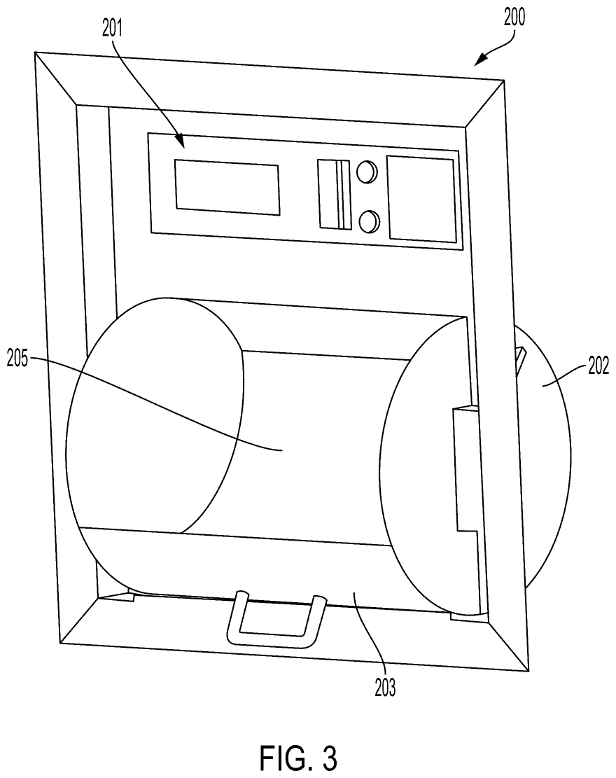

FIGS. 2-10 illustrate the point-of-pay (POP) or point-of-sale (POS) digital payment system 200 integrated with each of the commercial waste compactors. The POP/POS digital payment system kiosk 201 (as shown in FIG. 3) houses the payment electronics, control systems, and user interface components. Unlike prior art systems such as the '743 publication which merely provide a locked container that unlocks upon payment, the present system integrates sophisticated cycle-based access control, real-time weight monitoring, and automated compaction triggering.

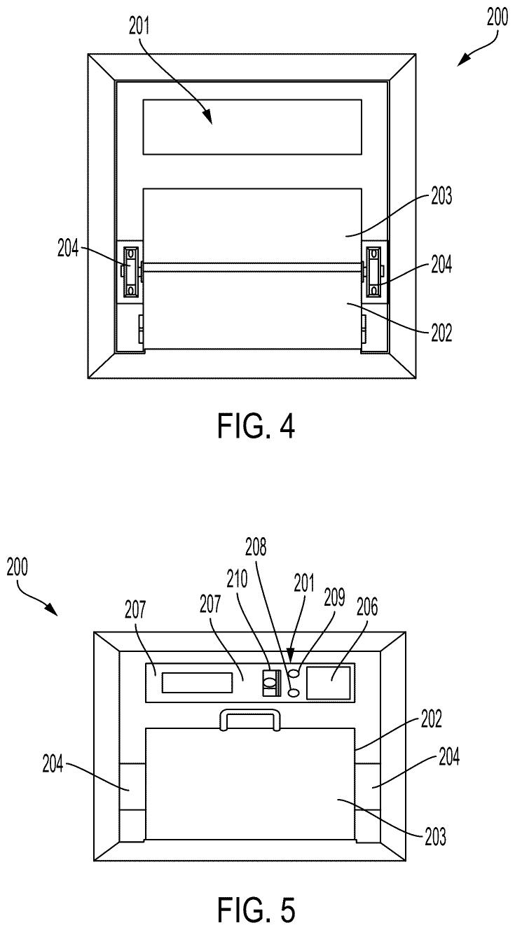

The sized receiving bin 202 is configured with specific volumetric capacity (for example, 0.25 cubic yards, 0.5 cubic yards, or 1.0 cubic yard) to limit the amount of waste accepted per cycle. The automated access door 203 is mounted on the receiving bin via special roller bearings 204 (as shown in FIGS. 4-6) that also incorporate weight scales for measuring deposited waste in real-time. This integration of weight measurement directly into the door mechanism distinguishes the present system from prior art and enables precise tracking of waste quantities for billing, capacity management, and verification purposes.

The receiving bin 202 has a fixed volume and/or weight capacity 205. When the bin is full (either by volume or by reaching a predetermined weight threshold), or when manually signaled by the user, the automated access door 203 closes and the bin contents are deposited into the compaction chamber 153 below.

FIG. 5 shows the user interface components of the POP/POS digital payment system kiosk 201 including: a digital screen display 206 for presenting information, prompts, and system status to users; a digital keyboard/display panel 207 for user input; activation button(s) 208 for initiating transactions or confirming actions; deactivation button(s) 209 for canceling transactions or signaling completion; and a payment collection device 210.

The payment collection device 210 may comprise multiple payment modalities including: NFC/contactless readers for tap-to-pay transactions; mobile card terminals accepting credit/debit cards with chip and PIN or magnetic stripe; cash scanners and validators for accepting paper currency; barcode scanners for reading QR codes or data matrix codes from mobile device screens; token systems accepting physical or digital tokens; biometric scanners/readers for fingerprint, facial recognition, iris scanning, or voice recognition authentication; or other automated computer input devices configured to grant access upon successful payment authorization.

This multi-modal payment approach distinguishes the present system from prior art systems that typically support only one or two payment methods and enables deployment in diverse markets with varying payment preferences and accessibility requirements.

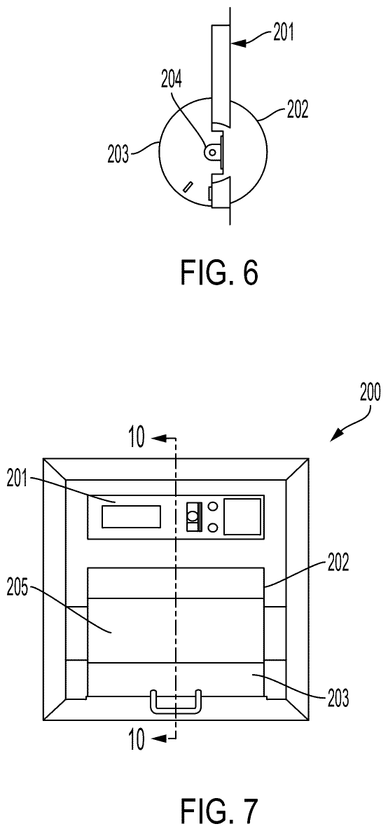

FIGS. 6, 7, 8, 9, and 10 illustrate the mechanical integration of the automated access door 203 with the sized receiving bin 202. In the closed position (FIG. 6), the door forms a sealed enclosure securing waste within the bin. Door sensors (not shown in these views but electrically connected to the PLC) detect the closed state. In the open position (FIG. 10), the door provides access for users to deposit waste items into the receiving bin 202. The door travel is controlled by actuators (such as linear actuators, pneumatic cylinders, or motor-driven mechanisms) commanded by the PLC.

The electronic door lock mechanism (not visible in exterior views) engages a locking pin, bolt, or latch that physically prevents door opening when engaged. Upon receiving authorization from the PLC, the lock actuator (such as a solenoid, motor, or pneumatic cylinder) retracts the locking element, permitting the door to be opened by the user.

Unlike the prior art, such as the '743 publication which discloses a simple unlock-upon-payment mechanism, the present system provides:
a. Cycle-based access control: A single payment authorizes a specific number of door open/close cycles (e.g., 3 cycles, 5 cycles, or 10 cycles depending on payment amount), not just a single access event. The PLC maintains a cycle counter and automatically re-locks the door when the authorized cycle count is exhausted:
   b. Dual threshold operation: The system operates with two independent thresholds: (a) a user cycle limit controlling how many times the door can be opened per payment; and (b) a compaction trigger threshold based on cumulative fill level across multiple user transactions. These thresholds are independently configurable and provide operational flexibility not disclosed in any prior art:
   c. Integration with compaction equipment: The receiving bin deposits contents into an actual compaction chamber where hydraulic rams compress the waste, rather than simply collecting waste in a container for later manual removal: and
   d. Real-time weight monitoring: Integrated weight scales in the door mechanism provide continuous weight measurement, enabling weight-based billing, capacity management, and verification that deposited materials match user declarations.

### Control Cabinet and Controller System Architecture

FIG. 11 and FIG. 13 illustrate an example control enclosure or control cabinet hardware and interfaces that may contain a controller (e.g., PLC), wiring, protection devices, and interfaces to sensors and actuators. In some embodiments, the controller coordinates POP/POS authorization, door locking/unlocking, cycle counting, optional capacity monitoring, optional compaction actuation, and reporting/diagnostics.

FIG. 11 illustrates the system composition and cloud integration architecture. The local system installation comprises a metal enclosure housing the control electronics, including:
a. Programmable Logic Controller (PLC): A ruggedized industrial controller configured to execute the state-based control logic described herein. The PLC interfaces with all sensors and actuators, coordinates operations between subsystems, and manages communications with cloud services.
b. Human-Machine Interface (HMI): In some embodiments, the cabinet includes a local user interface (e.g., an HMI or POP/POS Kiosk) for user prompts, status messaging, and authorized maintenance access. A touchscreen display (such as a 10″ or 15″ industrial touchscreen with IP 65 or better environmental rating) providing local user interaction. The HMI displays prompts, system status, pricing information, and instructions to users. It also provides a maintenance interface for authorized personnel to access diagnostic functions and manual controls.
c. Sensor Array: Multiple sensors provide real-time system state information:
   i. GPS position sensor: Provides geolocation data for asset tracking, particularly important for mobile compactor units as previously described.
   ii. Video cameras: Multiple cameras with fields of view encompassing customer interaction areas (for security), the receiving bin interior (for content verification), and the compaction chamber (for monitoring ram position and confirming operation). Cameras may include standard visible-light cameras and infrared cameras.
   iii. Thermal imaging cameras: Infrared cameras positioned to observe the contents of the receiving bin 202 and detect elevated thermal signatures indicating potential fire hazards, exothermic chemical reactions, or improperly disposed hazardous materials. This thermal monitoring capability is not disclosed in any prior art waste compaction system and provides a critical safety advantage.
   iv. Fire detection sensors: Smoke detectors, heat sensors, and/or flame detectors positioned within the compactor enclosure to detect fire conditions.
   v. Door lock position sensors: Magnetic reed switches, hall-effect sensors, or limit switches that detect whether the electronic door lock is engaged or disengaged, providing verification of lock status.
   vi. Door position sensors: Magnetic reed switches, hall-effect sensors, or proximity sensors that detect whether the automated access door 203 is open or closed.
   vii. Content level sensors: Ultrasonic distance sensors, laser rangefinders, or mechanical limit switches positioned within the compaction chamber 153 to detect fill level. Multiple sensors at different heights may be used to provide graduated fill status (e.g., 25%, 50%, 75%, 100% full).
   viii. Weight sensors: Load cells or strain gauges integrated into the receiving bin door mechanism 204 and optionally integrated into the compaction chamber floor to measure deposited waste weight.
   ix. Hydraulic pressure sensors: Pressure transducers on hydraulic lines to the compactor ram 155, providing information on compaction force, ram position (via pressure differential), and hydraulic system health.

### Actuator Control Systems

In some embodiments, the cabinet includes operator controls such as an emergency stop, a keyed maintenance enable, or other override controls for safe service operations.

In some embodiments, the cabinet includes:
a. Electronic door lock actuators: Solenoids, motors, or pneumatic cylinders controlled by the PLC to engage/disengage the door lock mechanism.
b. Hydraulic motor controllers: Variable frequency drives (VFDs), contactors, or proportional valves controlling the hydraulic pump motor that powers the compactor ram 155. The PLC commands ram extension, retraction, and force modulation.
c. Indicator lights and alarms: LEDs for status indication (e.g., available, in use, out of service), illumination lights for customer areas and internal cameras, and audible alarms for safety and notification purposes.

In some embodiments, the controller compares the usage-cycle counter to the authorized cycle count after each door-closed condition, and the controller re-locks the access door when the usage-cycle counter reaches the authorized cycle count, unless early completion has already caused re-locking. This definition avoids ambiguity by tying counting to a completed open→close cycle and avoids double-counting due to sensor bounce or partial door motion.

### Safety, Fault Handling and Interlocks

In some embodiments, the controller implements a “fail-locked” access policy such that if a required sensor is unavailable or contradictory, the controller commands the door to remain locked and enters a fault state. The fault state may include logging the fault, displaying an out-of-service message, optionally notifying a remote operator, and requiring an authorized reset before resuming normal operation.

### Door Sensor Failure Handling

If the door position sensor indicates an impossible state, becomes unresponsive, or produces signals outside expected timing windows, the controller transitions the system to a fault state and commands the lock actuator to lock. In some embodiments, if the door is physically open when the fault is detected, the system may (i) inhibit counting, (ii) issue a local alarm, and (iii) disallow further authorizations until the door is closed and an authorized reset is performed.

### Lock Sensor Disagreement Handling

In some embodiments, the system includes a lock-position sensor that indicates whether the lock is engaged or disengaged. If the controller commands unlock but the lock-position sensor indicates “locked,” or if the controller commands lock but the lock-position sensor indicates “unlocked,” the controller enters a fault state, prevents continued user access, and generates a maintenance alert and/or service notification.

### Emergency Stop Behavior

In some embodiments, an emergency stop input immediately disables at least one of (i) door motion actuation (if present), (ii) compactor actuation (if integrated), and (iii) other powered motion, while commanding the access door to a safe state (typically locked when feasible).

In some embodiments, clearing the emergency stop does not automatically resume operation, and instead the controller requires a deliberate reset action and may require maintenance authentication.

### Optional Weighing and Deposit Management

In some embodiments, the system includes one or more weight sensors (e.g., load cells integrated into a door mounting or receiving bin structure) that produce measured weight values associated with deposits.

In some embodiments, the controller samples weight during a cycle and stores a weight value for that cycle (e.g., a stable weight after door closure) and associates it to the transaction session record.

In some embodiments, the system supports weight-based billing, cycle-based billing, or hybrid billing, with weight values used to compute a final amount for the session.

In some embodiments, the system also uses measured weight as an operational indicator for maintenance or capacity prediction.

### Thermal Monitoring

In some embodiments, the system includes at least one thermal sensor or thermal imaging camera positioned to observe contents of the receiving bin and/or compaction chamber.

In some embodiments, the controller analyzes thermal data to detect thermal signatures exceeding a temperature threshold indicative of hot debris, fire risk, or prohibited materials.

### Example Thresholding and Processing (High Level)

In some embodiments, the controller calculates a “hotspot metric” as a maximum observed temperature within a defined region of interest inside the receiving bin, optionally after applying basic spatial filtering and temporal smoothing across multiple frames.

In some embodiments, the controller compares the hotspot metric to a hazard threshold T_{haz} and uses a time-over-threshold rule (e.g., exceeding T_{haz} for N consecutive frames or for at least X seconds) to reduce false positives.

### Example Calibration and Drift Handling (High Level)

In some embodiments, the system performs calibration by establishing a baseline ambient temperature estimate T_{amb} using (i) an initial power-up sampling window and/or (ii) periodic sampling during known-empty bin conditions, and then evaluates hotspot conditions using ΔT=Tₕₒₜₛₚₒₜ−T_{amb}.

In some embodiments, the system applies a hysteresis band so that once a hazard is declared, the hazard clears only after the hotspot metric falls below a lower clear threshold T_{clear}<T_{haz} for a defined duration.

### Example False-positive Mitigation

In some embodiments, the controller optionally cross-checks a thermal hazard determination with at least one additional signal, such as a smoke/heat sensor, a door-open timer anomaly, or a camera classification event, and then escalates to a lockout only when one or more corroborating conditions are present.

In some embodiments, the system logs the thermal event and stores a short “event window” of thermal measurements and/or images for operator review.

### Lockout Behavior

In some embodiments, upon detecting a hazard condition, the controller prevents subsequent unlocking of the access door and requires an authorized reset before re-enabling access.

In some embodiments, the authorized reset can be performed by keyed switch, maintenance credential at the HMI, and/or remote authorization through a cloud administrator interface.

### Communications, Buffering and Cloud Services

In some embodiments, the system includes at least one communication interface configured for network communication with remote cloud services.

In some embodiments, the system transmits operational data including transaction records, cycle counts, measured weights (if available), fault codes, and diagnostic reports.

In some embodiments, the system includes local non-volatile storage and buffers data during connectivity loss and then uploads buffered data after connectivity is restored.

In some embodiments, cloud services provide dashboards, notifications, analytics, and configuration management for parameters such as pricing tiers, authorized cycle counts, and safety thresholds.

### Communication Systems

In some embodiments, the system includes multiple communication pathways for redundancy and diverse deployment scenarios:
Ethernet: Wired network connection for high-bandwidth, low-latency communication when available.
WiFi: Wireless local area network connectivity, configurable as client (connecting to existing WiFi network) or access point (creating a network for mobile device access).
Cellular: 4G LTE or 5G cellular modem with embedded SIM or external SIM card, enabling deployment in locations without wired network infrastructure.
LoRaWAN or other IoT networks: Long-range, low-power wireless for remote locations where cellular coverage is limited.

In some embodiments, a key distinguishing feature enabling true 24/7/365 (continuous, uninterrupted 24-hour operation, year-round) autonomous operation:
a. Grid Power Input: Three-phase 240VAC or single-phase 120/240VAC connection to facility power where available.
b. Solar Power System: Photovoltaic panels (optionally roof-mounted on the compactor enclosure) with solar charge controllers providing DC power to battery banks and/or DC-AC inverters.
c. Battery Backup: Deep-cycle batteries (such as lithium iron phosphate, AGM, or gel-cell batteries) providing energy storage for overnight operation of solar-powered systems and backup power during grid outages.
d. Generator: Optional connection for portable generator or permanently installed generator for extended off-grid operation.
e. Automatic Transfer Switching: Power management circuitry that automatically transitions between power sources based on availability and priority, without interrupting PLC operation. For example: (i) grid power preferred when available; (ii) solar power used during daylight with excess charging batteries; (iii) battery power used at night or during grid outages; (iv) generator auto-started upon detecting extended grid outage with low battery state of charge.
f. Uninterruptible Power Supply (UPS): Integrated UPS circuitry providing ride-through power during source transitions, ensuring the PLC and safety-critical systems maintain continuous operation.

This comprehensive power management system distinguishes the present invention from all prior art waste compaction systems, which rely solely on grid power and cannot operate during power outages, thus failing to provide true 24/7/365 availability.

### Cloud Interface and Services Integration

FIG. 12 details the cloud services platform accessible via API interfaces. The local system establishes bidirectional communication with cloud servers, enabling:
1. Data Logging and Storage: All transaction records, sensor data, diagnostic reports, and video footage are uploaded to cloud storage for long-term retention and analysis. Data includes: timestamp of each transaction; user identification if provided (e.g., via account login, RFID card, or biometric); payment method and amount; number of cycles used; weight and/or volume of material deposited; system location via GPS; and system health metrics.
2. Payment Processing Services: Integration with payment networks (such as Stripe, Square, PayPal, or direct processor integration) for real-time payment authorization and settlement. The cloud platform manages merchant accounts, processes credit/debit card transactions, handles chargebacks, and generates financial reports.
3. Real-Time Notifications: Automated notification generation based on predefined trigger conditions, sent via email, SMS, push notifications to mobile apps, or phone calls. Notifications include:
   Service dispatch: Generated when fill level sensors indicate the receiver box 108 is approaching capacity (e.g., 80% or 90% full), notifying waste hauling services to schedule pickup. Includes GPS location, estimated time until full, and current weight.
   Maintenance alerts: Generated upon detection of system faults during diagnostic routines, such as sensor failures, hydraulic pressure anomalies, communication link loss, or battery low voltage. Includes fault description, timestamp, system location, and recommended actions.
   Security alerts: Generated upon detection of tampering (via vibration sensors or accelerometers), unauthorized access attempts, unauthorized transport attempts, or thermal signatures indicating a fire or hazardous material deposition.
   Status updates: Periodic reports (e.g., daily, weekly) summarizing transaction counts, revenue, capacity utilization, and system uptime.
4. Analytics Dashboards: Web-based and mobile app interfaces providing operators and administrators with real-time and historical data visualization, including:
   Transaction analytics: Charts and graphs showing transaction volume by time of day, day of week, location; revenue trends; average transaction size; payment method distribution.
   Capacity analytics: Fill level trends; compaction cycle frequency; waste density calculations; predictions of when receiver box will require emptying.
   System health: Equipment uptime; fault frequency and types; sensor data trends; predictive maintenance recommendations based on hydraulic pressure patterns or cycle count thresholds.
   Fleet management: For operators deploying multiple units, dashboards showing status of all systems on maps, comparative performance metrics, and fleet-wide analytics.
5. Video Feed Transmission and Storage: Real-time or periodic video streaming from installed cameras to cloud storage, enabling remote visual inspection of operations, review of security events, and verification of proper use.
6. Remote Control and Configuration: Authorized users can remotely access systems via cloud interfaces to:
   Monitor: View live sensor data, camera feeds, and system status.
   Configure: Adjust operational parameters such as pricing ($/cycle, $/lb, or tiered rates), cycle limits per payment, compaction trigger thresholds, notification settings, and scheduled operations.
   Control: Remotely lock/unlock doors (for maintenance or emergency response), initiate compaction cycles, trigger diagnostics, reboot controllers, or disable systems.

### State Machine Control Logic—Operations Flow

FIG. 14 illustrates the state-based control logic executed by the PLC to coordinate autonomous operations. This control architecture provides significant advantages over prior art by explicitly defining system states, transitions, and actions, enabling deterministic operation and simplified troubleshooting.

### State 1: Standby/Initialize

The system begins in a standby state upon power-up or completion of a previous transaction. In this state:
a. The electronic door lock is engaged, physically preventing door opening.
b. The HMI displays an “Available” or “Ready” message and pricing information.
c. The payment device is enabled and monitoring for payment input.
d. All sensors are polled to verify functionality.
e. The system awaits a payment authorization signal.

### State 2: Payment Authorization

Upon detecting payment input (e.g., card tap, QR code scan, biometric authentication), the system transitions to payment authorization:
a. The payment processor communicates with financial networks (via the cloud services platform or direct processor connection) to authorize the transaction.
b. The PLC waits for authorization confirmation (typically 1-3 seconds for card payments).
c. If authorization fails (e.g., insufficient funds, invalid card, network timeout), the system displays an error message and returns to standby without unlocking the door.
d. If authorization succeeds, the system proceeds to State 3.

### State 3: Access Granted/Unlocked State

Upon receiving authorization confirmation:
The PLC stores an authorized cycle count based on the payment amount or payment type. For example: $5 payment=5 cycles; $10 payment=10 cycles; monthly subscription account =unlimited cycles for the billing period.
The PLC Initializes a usage cycle counter to zero.
The PLC commands the electronic door lock actuator to disengage the lock.
The PLC verifies lock disengagement via lock position sensors.
The HMI displays a message such as “Access Granted-Door Unlocked” and indicates the number of cycles available.
The system waits for the user to open the door.

This cycle-based access control is a key distinguishing feature. Unlike prior art such as the '743 publication where payment provides a single access event, the present system enables multiple disposal cycles per payment, improving user experience and enabling flexible pricing models.

### State 4: Door Open

Upon detecting door opening via door position sensors:
The PLC increments the usage cycle counter.
The PLC starts a timer to limit door open duration (e.g., 60 seconds maximum).
The HMI displays a message such as “Place Waste in Bin”.
Weight sensors 204 continuously measure the weight of deposited material.
Thermal imaging cameras scan the deposited contents for elevated thermal signatures.
The system waits for the user to close the door or for the timer to expire.

If the timer expires with the door still open, the system may: (a) sound an audible alarm prompting the user to close the door; or (b) automatically close the door via a motor-driven door mechanism if so equipped.

### State 5: Door Closed/Cycle Evaluation

Upon detecting door closing via door position sensors:
The PLC reads the weight measurement from sensors 204 and stores the weight value with the transaction record.
The PLC compares the usage cycle counter to the authorized cycle count.

If usage cycle counter<authorized cycle count AND user has not signaled transaction completion:
The PLC maintains the door lock in the disengaged state.
The receiving bin contents are deposited into the compaction chamber 153 (via a chute, trap door, or tilting mechanism).
The receiving bin is reset to empty for the next cycle.
The HMI displays an updated message indicating remaining cycles (e.g., “3 Cycles Remaining”).
The system returns to State 3 (unlocked, waiting for next door opening).

If usage cycle counter ≥authorized cycle count OR user has pressed “Done”/“Finish” button:
The system proceeds to State 6 (Transaction Completion).

This logic enables the multi-cycle operation per payment that distinguishes the present system from prior art.

### Parallel Process: Capacity Monitoring and Compaction Trigger

Throughout States 3-5, the PLC continuously monitors fill level sensors in the compaction chamber 153. This monitoring operates in parallel with the user transaction logic:
Fill level sensors (ultrasonic, laser, or limit switches) detect the height of accumulated waste in the compaction chamber.
The PLC compares the fill level to a compaction trigger threshold (e.g., 75% full, or a specific distance measurement).
When fill level exceeds the compaction trigger threshold:
The PLC disables further door unlocking (any users awaiting access see “Temporarily Unavailable-Compacting” message).
The system proceeds to State 7 (Compaction Cycle).

This dual-threshold operation (user cycle limits +compaction trigger threshold operating independently) is a novel feature not disclosed in any prior art reference. It enables the system to optimize compaction efficiency while providing predictable user experience.

### State 6: Transaction Completion

Upon reaching the authorized cycle limit or receiving user signal of completion:
The PLC engages the electronic door lock.
The PLC verifies lock engagement via lock position sensors.
If the actual cycles used are fewer than the authorized cycles (user finished early), the PLC calculates a refund amount or credits the difference to a user account if using account-based billing.
If using weight-based billing, the PLC calculates the total cost based on total weight deposited across all cycles: Cost=(Total Weight in lbs)×(Rate $/lb).
The PLC processes the final payment transaction via the payment processor, either capturing the pre-authorized amount, charging the calculated amount, or processing a refund.
The PLC generates a transaction receipt (displayed on HMI and/or printed) showing: transaction ID, timestamp, cycles used, weight deposited, amount charged, payment method.
The PLC updates internal logs and prepares transaction data for cloud transmission.
The system proceeds to State 8 (Diagnostics).

### State 7: Compaction Cycle

When fill level exceeds the compaction trigger threshold:
The PLC disables customer access functions (door remains locked even for authorized users).
The HMI displays “Compacting-Please Wait” or “Temporarily Unavailable”.
The PLC commands the hydraulic motor controller to activate the hydraulic pump.
The hydraulic ram 155 extends into the compaction chamber 153, compressing accumulated waste and pushing compacted waste through the discharge door 159 into the receiver box 108.
The PLC monitors hydraulic pressure sensors to detect:
   Completion: When pressure exceeds a threshold indicating waste is fully compacted against the receiver box.
   Anomalies: Abnormally high pressure (indicating blockage or overload) or abnormally low pressure (indicating hydraulic leak or pump failure).
Upon detecting completion, the PLC commands ram retraction, returning the ram to home position.
The PLC re-evaluates fill level sensors:
If fill level is now below the compaction trigger threshold: The system re-enables customer access, returning to standby state to accept new transactions.
If fill level remains high (receiver box is full): The system enters “Out of Service” mode, displaying “Full-Service Required” and transmitting urgent service dispatch notification to cloud services with GPS location and estimated current weight. The system remains locked and unavailable until service personnel empty the receiver box and manually reset the system (or remotely reset via cloud interface after confirming service completion).

### State 8: Diagnostics and Cloud Reporting

Following each transaction completion (or periodically, e.g., every 15 minutes), the PLC executes automated diagnostic routines:
1. Sensor Verification: The PLC polls each sensor (door sensors, lock sensors, weight sensors, fill level sensors, pressure sensors, cameras, thermal sensors) and verifies that each responds with valid data within expected ranges. Failed sensors are flagged in diagnostic reports.
2. Actuator Verification: The PLC commands each actuator (lock, door mechanism, hydraulic system, lights, alarms) to a test state (if safe to do so without disrupting operations) and verifies state change via sensors. Non-responsive actuators are flagged.
3. Communication Verification: The PLC checks connectivity to cloud services by sending a heartbeat message and awaiting acknowledgment. Communication failures are logged and retried with exponential backoff.
4. Power System Verification: The PLC monitors voltage levels on grid power input, battery voltage and state of charge, solar panel output (if present), and UPS status. Low voltage conditions, charging failures, or power source unavailability are flagged.
5. Memory and Processing Verification: The PLC runs internal diagnostics checking memory integrity (via checksums), CPU load, and storage capacity. Anomalies are flagged.
6. Diagnostic Report Generation: The PLC compiles a diagnostic summary including pass/fail status for each subsystem, sensor readings, fault flags, and timestamp.
7. Cloud Data Transmission: The PLC uploads: (a) completed transaction records; (b) diagnostic reports; (c) sensor data logs; (d) video footage (if configured for periodic upload or event-triggered upload); (e) system status update.
8. Notification Generation: Based on diagnostic results and operational thresholds, the PLC generates notifications (via cloud services platform) as described previously.

Upon completing diagnostics and cloud reporting, the system returns to State 1 (Standby), ready for the next transaction.

### Customer Transaction Flow

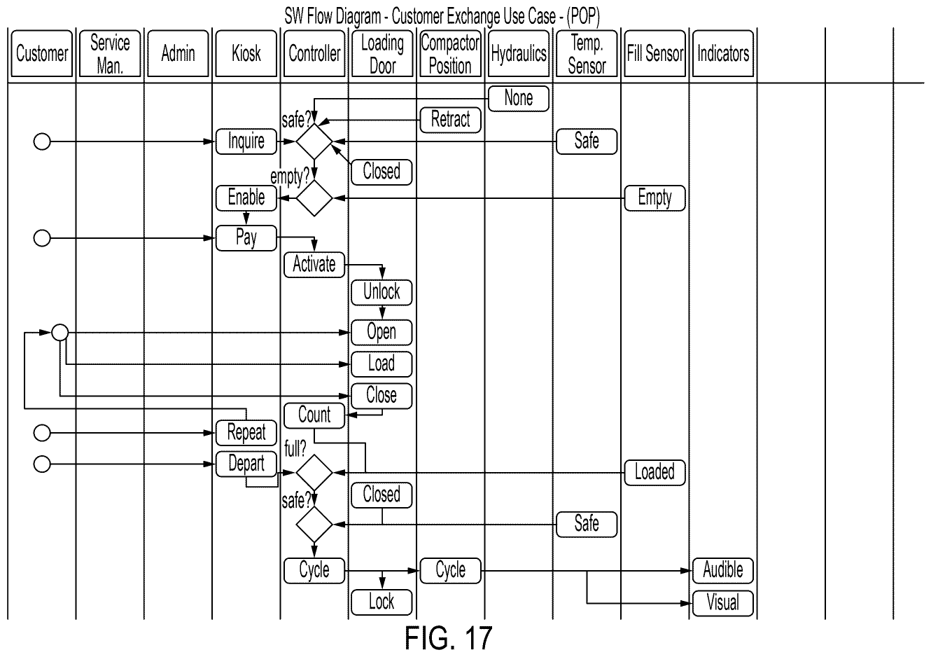

FIG. 17 illustrates the user experience workflow from the customer's perspective. A customer approaches the system and initiates interaction with the HMI touchscreen. The HMI displays pricing options (e.g., “$5 for 5 cycles”, “$10 for 10 cycles”, “Monthly Account Login”). The customer selects a payment method and presents credentials:
Credit/debit card: Tap card on NFC reader or insert chip card into card reader and enter PIN if required.
Mobile payment: Scan QR code displayed on HMI with mobile banking app, or present mobile wallet (Apple Pay, Google Pay) to NFC reader.
Cash: Insert bills into cash validator.
Token: Insert physical token or scan digital token barcode.
Biometric: Place finger on fingerprint scanner or look at facial recognition camera.
Account login: Enter account number via keypad or scan account QR code.

The payment authorization occurs (as described in State 2 above), typically completing in 1-3 seconds. Upon successful authorization, the HMI displays “Access Granted” and the door unlocks with an audible confirmation (e.g., beep or click).

The customer opens the door manually (the door may be spring-loaded to assist opening, or motor-driven to automatically open upon unlock). The customer places waste items into the receiving bin 202. Infrared thermal cameras positioned to view the bin interior scan the deposited contents. If elevated thermal signatures are detected (indicating potential fire hazards or hot materials), the system generates an alert notification and optionally displays a warning message to the customer.

The customer closes the door. The system detects door closure, increments the cycle counter, and evaluates whether additional cycles are available. If cycles remain, the HMI displays “X Cycles Remaining-Door Unlocked” and the customer may open the door again to deposit additional waste. This process repeats until the authorized cycle count is exhausted or the customer presses “Done”.

Upon transaction completion, the system processes final payment (as described in State 6), displays or prints a receipt, and runs diagnostics. The customer departs, and the system returns to standby for the next customer.

This autonomous operation enables deployment in public locations (such as parks, rest stops, public works yards) or commercial locations (such as construction sites, warehouses, retail centers) where traditional compactors requiring on-site operators would be impractical or too costly.

maintenance and Administration Operations

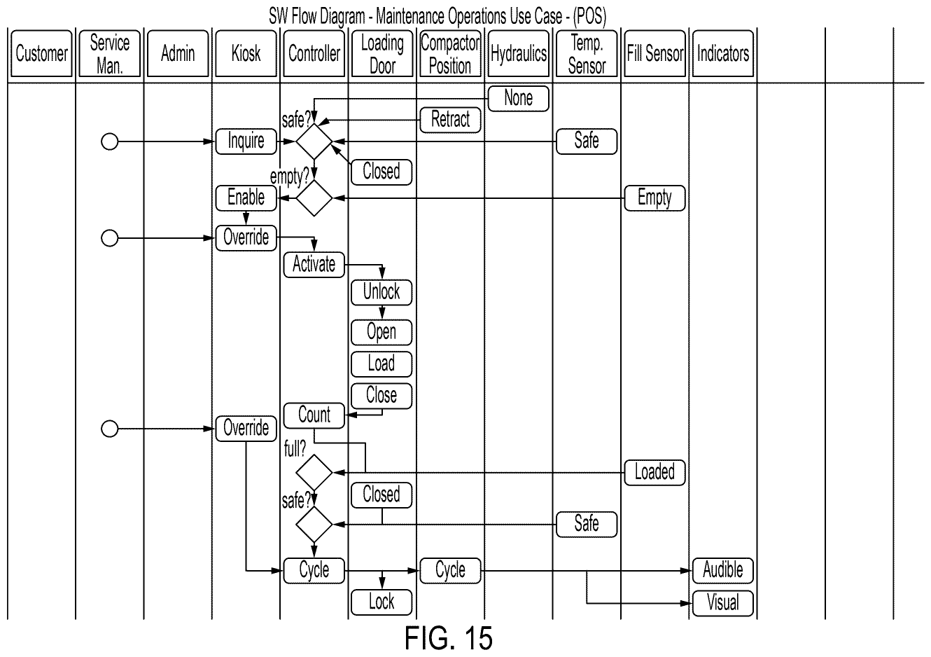

FIG. 15 illustrates the maintenance operations workflow. Authorized maintenance personnel can access the system via:
1. Local Maintenance Access Terminal: A separate interface on the HMI accessed via passcode or key switch, providing diagnostic data display, manual control functions, and configuration settings.
2. Mobile Device: A mobile app (iOS/Android) that communicates with the system via Bluetooth, WiFi, or cellular, providing remote diagnostics and control when on-site.

Maintenance functions include:
Diagnostic Data Review: View sensor readings, fault logs, transaction history, and system status.
Manual Controls: Manually unlock/lock doors, trigger compaction cycles, activate lights and cameras for inspection, test sensors and actuators.
Configuration: Adjust operational parameters (pricing, cycle limits, compaction thresholds, notification settings, scheduled operations).
Override Functions: Bypass normal operational logic for troubleshooting or emergency response (e.g., manually override lock to free jammed mechanism).
Firmware Updates: Upload new PLC programs or HMI software via USB or network connection.

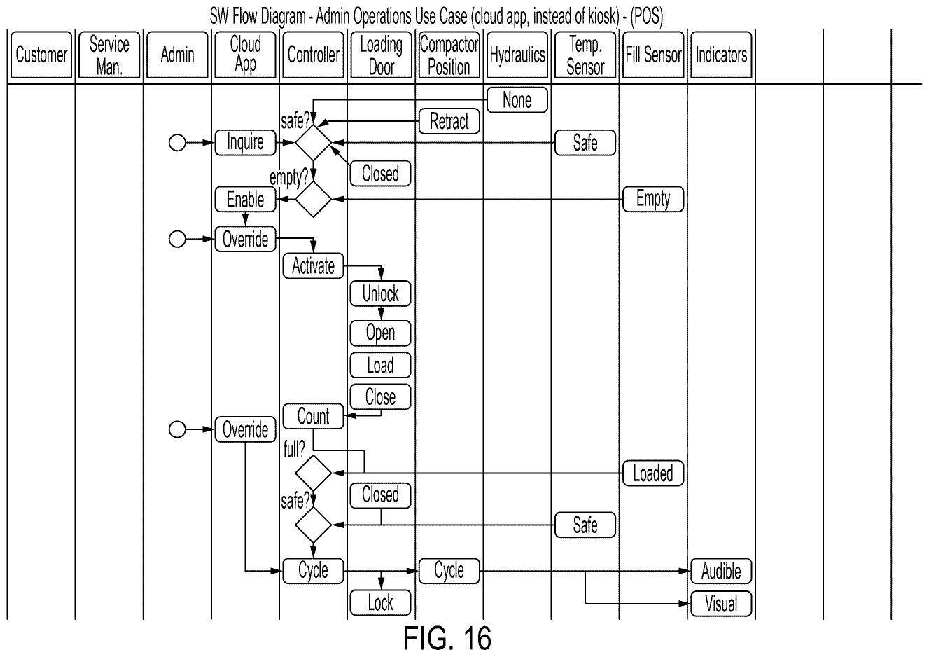

FIG. 16 illustrates the administrator operations workflow via cloud application. System operators and administrators access a web-based dashboard or mobile app that communicates with cloud services. Administrator functions include:
a. Fleet Monitoring: For operators deploying multiple systems, a map view shows location and status of all units with color-coding (green=operational, yellow=service needed soon, red=out of service or fault detected).
b. Analytics and Reporting: Access to all analytics dashboards described previously, with export functionality for financial reporting, operational analysis, and regulatory compliance.
c. Remote Control: All maintenance functions described above performed remotely via cloud interface rather than requiring on-site access.
d. User Account Management: For systems configured for account-based access, administrators manage user accounts, view per-user transaction history, adjust user-specific pricing or limits, and handle billing issues.

### Advantages Over Prior Art

The cloud-integrated autonomous waste compaction system disclosed herein provides numerous advantages over prior art:
1. True Autonomous Operation: Unlike prior art systems requiring on-site operators or limited to secured locations, the present system enables deployment in public or commercial locations with unattended autonomous operation 24/7/365, enabled by integrated payment authorization, electronic access control, automated compaction triggering, comprehensive sensor monitoring, multi-source power management, and cloud-based remote monitoring.
2. Cycle-Based Access Control: The novel cycle counting mechanism with separate user cycle limits and compaction trigger thresholds provides operational flexibility not disclosed in any prior art, enabling pricing models based on number of disposal cycles, weight, volume, or combinations thereof, while optimizing compaction efficiency.
3. Enhanced Safety: Infrared thermal imaging for detecting hazardous materials, fire detection systems with automated suppression, and real-time video monitoring provide safety capabilities not disclosed in prior art waste compaction systems.
4. Predictive Maintenance: Continuous monitoring of hydraulic pressure patterns, cycle counts, sensor health, and other operational parameters enables predictive maintenance scheduling, reducing downtime and repair costs compared to reactive maintenance approaches used with prior art compactors.
5. Revenue Generation and Cost Recovery: The integrated payment system enables municipalities, businesses, and private operators to generate revenue from waste disposal services or recover costs from users, rather than providing free disposal which encourages excessive waste generation. Weight-based billing provides incentive for waste minimization.
6. Comprehensive Data Collection: Real-time tracking of waste quantities (by weight and volume), disposal patterns (time/date/location), and user behavior provides valuable data for waste management planning, regulatory compliance, and operational optimization not available with prior art systems.
7. Flexible Deployment: The multi-source power management system enables deployment in remote locations without grid power (using solar+battery), temporary locations (using generator or battery), or grid-connected locations with backup power for uninterrupted operation during outages, providing deployment flexibility not achievable with grid-dependent prior art systems.

### EXAMPLE EMBODIMENTS

Embodiment 1—Municipal Public Works Yard: A municipality deploys a stationary compactor 120 with detachable receiver box 108 at a public works facility. Residents access the facility during posted hours (e.g., 6 AM-8 PM daily) to dispose of bulky waste, construction debris, or yard waste. Users pay per disposal cycle using credit/debit cards or prepaid municipal account cards. The system weighs each deposit and charges based on weight ($0.10/lb). When the receiver box reaches 80% capacity (for example), the system automatically notifies the municipal hauling department to schedule pickup. The municipality generates revenue from non-resident users while providing cost-recovery service to residents and collects data on waste generation patterns for planning purposes.

Embodiment 2—Construction Site: A contractor deploys a mobile compactor system with the inventive HMI (as previously described) at a remote construction site without grid power. The compactor is powered by roof-mounted solar panels with battery backup. Construction workers access the compactor using company-issued RFID cards linked to project accounts. Each use is tracked by user, date/time, and weight for job costing and waste reporting. When the receiver box is full, the compactor is transported to a disposal facility using the integrated mobility features and returned to site. The autonomous operation eliminates the need for dedicated waste management personnel on site.

Embodiment 3—Public Park/Recreation Area: A parks department deploys a self-contained mobile compactor trailer with the inventive HMI (as previously described) at a popular park during peak season. The trailer is towed to the location and connected to grid power. Public users access the compactor by paying per cycle using credit/debit cards, cash, or mobile payments ($2 per cycle, 3 cycles authorized). The compactor is equipped with external security cameras and lighting, providing a safe disposal location available 24 hours per day. Thermal imaging cameras detect improper disposal of hot charcoal or other fire hazards, generating immediate alerts to park rangers or fire services. The system reduces overflowing trash cans and littering, improving park cleanliness.

Embodiment 4—Commercial Waste Management Service: a Waste Management company deploys multiple self-contained compactor trucks with the inventive HMI (as previously described) at various commercial customer locations (retail centers, warehouses, manufacturing facilities). Each truck remains on-site for a defined period (e.g., one week), with customers accessing the compactor using account-specific QR codes scanned from mobile devices. The waste management company bills customers based on actual usage (weight-based pricing), eliminating flat-rate billing that doesn't reflect actual waste generation. The cloud-based fleet management system optimizes truck routing, ensuring trucks are moved to new locations or emptied based on real-time fill level data across the entire fleet, reducing idle time and improving asset utilization.

Embodiment 5—Industrial Facility: A manufacturing facility deploys a stationary industrial compactor 120 with the inventive HMI (as previously described) at a loading dock for cardboard and packaging waste. Employees access the compactor using biometric fingerprint scanners, with usage tracked by employee ID for departmental cost allocation. The compactor is configured with a large receiving bin (1.5 cubic yards) allowing deposit of collapsed cardboard boxes. The system tracks waste generation by department, identifying opportunities for waste reduction and recycling improvements. Integration with the facility's existing waste management database enables comprehensive sustainability reporting.

### Alternative Embodiments and Variations

While specific embodiments have been described, those skilled in the art will recognize that various modifications and alternatives may be employed without departing from the scope of the invention:
a. Payment Variations: While credit/debit cards and NFC contactless payments are primary payment modalities, alternative embodiments may emphasize different payment methods based on deployment location and target users. For example: (i) cash-only systems for locations where card payment infrastructure is unavailable or users prefer cash; (ii) token-based systems where tokens are purchased separately (such as those found in self-serve car wash locations) and used for payment, enabling pre-payment or gift card functionality; (iii) account-based systems requiring user login via PIN, card, biometric, or mobile app, with billing processed periodically rather than per-transaction; (iv) blockchain-based payment using cryptocurrency wallets; (v) hybrid systems accepting multiple payment modalities simultaneously.
b. Receiving Bin Configurations: While a single fixed-volume receiving bin 202 is shown in the figures, alternative embodiments may include: (i) multiple receiving bins of different sizes selectable by the user based on waste volume (small, medium, large); (ii) variable-volume bins with adjustable dividers or expandable walls; (iii) specialized bins for specific waste types (e.g., separate bins for recyclables, compostables, general waste) with the system prompting users to select waste type; (iv) bins with automated sorting mechanisms that separate deposited waste into multiple streams; (v) bins with integrated shredding or size reduction mechanisms that process waste before depositing into the compaction chamber.
c. Compactor Configurations: While hydraulic ram-type compactors are primary examples, alternative embodiments may integrate with different compaction technologies: (i) screw-type compactors using augers to compress waste; (ii) rotary compactors using rotating drums; (iii) baler-type compactors that compress and bind waste into bales; (iv) dual-ram systems with independent rams for different waste streams; (v) high-compaction systems achieving ratios of 10:1 or greater for specific waste types.
d. Sensor Configurations: While specific sensor types are described, alternative embodiments may substitute or supplement sensors: (i) 3D imaging cameras (such as LiDAR or structured light) providing volumetric measurement of deposited waste; (ii) X-ray or gamma-ray sensors for detecting prohibited materials (such as batteries, electronics, hazardous chemicals); (iii) chemical sensors detecting volatile organic compounds (VOCs) or other chemical signatures; (iv) RFID readers detecting RFID tags on waste items for inventory tracking; (v) AI-powered image recognition analyzing camera feeds to identify waste types and detect prohibited items.
e. Communication and Connectivity: While WiFi, Ethernet, cellular, and LoRaWAN are described, alternative embodiments may include: (i) satellite communication for extremely remote locations; (examples include: AST SpaceMobil®, SpaceX®/Starlink® (private), Iridium® Communications, EchoStar® and Viasat®, to name a few); (ii) mesh networking where multiple deployed units communicate with each other to extend network range; (iii) edge computing with local processing of video analytics and AI algorithms, reducing cloud bandwidth requirements; (iv) blockchain-based transaction logging for tamper-proof audit trails.
f. Power Systems: While grid, solar, battery, and generator power sources are described, alternative embodiments may include: (i) fuel cell power systems; (ii) wind power generation; (iii) kinetic energy harvesting from compaction cycles; (iv) vehicle power integration where mobile compactors draw power from tow vehicle electrical systems.

### Digital Processing Device and Software Components

In some embodiments, the system includes one or more digital processing devices configured to execute software applications for cloud services, mobile apps, or web-based dashboards. In further embodiments, the digital processing device includes one or more hardware central processing units (CPUs) or processors that carry out the device's functions.

Suitable digital processing devices for cloud services include server computers, which may be physical servers or virtual machines running on cloud computing infrastructure (such as Amazon Web Services, Microsoft Azure, Google Cloud Platform, or private cloud installations).

Suitable digital processing devices for operator/administrator access include desktop computers, laptop computers, tablet computers, and smartphones running operating systems such as Microsoft Windows, Apple macOS, Linux, Apple iOS, or Google Android.

The cloud-based software applications may be implemented as web applications accessible via web browsers (such as Chrome, Firefox, Safari, Edge) and/or mobile applications installed on smartphones or tablets. Web applications may be developed using frameworks such as React, Angular, Vue.js, or similar, with backend services implemented using Node.js, Python Django/Flask, Ruby on Rails, Java Spring, or similar frameworks. Mobile applications may be developed as native apps (using Swift for iOS, Kotlin/Java for Android) or cross-platform apps (using React Native, Flutter, Xamarin, or similar frameworks).

The system utilizes databases for storing transaction records, user accounts, sensor data, diagnostic logs, and video footage. Suitable database systems include relational databases (such as PostgreSQL, MySQL, Microsoft SQL Server, Oracle) for structured transaction data and user accounts, and NoSQL databases (such as MongoDB, Cassandra, or time-series databases like InfluxDB) for high-volume sensor data and logs. Video footage may be stored in object storage systems (such as Amazon S3, Azure Blob Storage, or Google Cloud Storage) with database records containing references to video files.

API (Application Programming Interface) services enable communication between local PLC systems and cloud services, and between cloud services and client applications (web browsers, mobile apps). APIs may be implemented using RESTful HTTP interfaces, GraphQL, WebSocket protocols for real-time data streaming, or MQTT for IoT device communication.

### Payment Processing

In some embodiments, the system supports a payment flow that uses pre-authorization followed by final capture at transaction completion. In an example implementation, after the user selects a pricing tier, the POP/POS subsystem performs a pre-authorization (or authorization) for an amount corresponding to that tier, and the controller unlocks the door after an approval signal is received.

In some embodiments, during the transaction session the controller tracks completed cycles and optionally measured weights, and at session completion the controller determines a final amount and requests capture for that amount (or an adjustment/refund as applicable).

In some embodiments, the receipt or transaction record includes at least a transaction identifier, timestamp, authorized cycle count, used cycle count, and any measured weights used for billing.

### Connectivity-loss Handling for Payments

In some embodiments, if network connectivity is unavailable before authorization, the system does not grant access and remains locked (fail-closed for payment authorization).

In some embodiments, if connectivity is lost after a pre-authorization has been obtained, the controller stores a “pending capture” record in local non-volatile storage and transmits the capture request when connectivity returns, and the system may optionally restrict new sessions until the pending capture queue is below a threshold.

### Offline Queue Integrity (High Level)

In some embodiments, queued payment events are stored with a tamper-evident structure such as a chained hash over sequential records, and each record may include a monotonic counter and timestamp to support later reconciliation.

In some embodiments, if the queue indicates inconsistencies, the controller enters a fault state and requests service.

Optional Integration with a Commercial Compactor and Compaction Control

In some embodiments, the POP/POS kiosk is integrated with a commercial compactor that includes a compaction chamber and a ram actuator.

In some embodiments, deposited waste is directed from the receiving bin into the compaction chamber, and compacted waste is discharged into a receiver box.

In some embodiments, the compactor can be triggered based on capacity monitoring such as fill level sensors, chamber pressure signatures, or receiver box indicators.

In some embodiments, compaction logic is interlocked so that access is denied (door locked) during compaction actuation, and compaction is inhibited if an emergency stop is active or if safety sensor criteria are not satisfied.

### Diagnostics and Maintenance Operations

In some embodiments, the controller runs periodic diagnostics and/or runs diagnostics at the end of a transaction session, including checks of sensor responsiveness, actuator response verification, communication status, and power status.

In some embodiments, diagnostic results are stored locally and transmitted to cloud services when connectivity is available.

In some embodiments, an authorized maintenance mode enables controlled manual actions such as lock/unlock tests, sensor readouts, and optional manual compaction commands.

In some embodiments, maintenance actions are logged with timestamps and identifiers.

Example Transaction Session (Multi-cycle per payment)

In an example transaction session, the user selects a tier corresponding to a plurality of cycles and completes POP/POS authorization. The controller unlocks the access door, initializes the usage-cycle counter to zero, and allows the user to perform repeated cycles until the authorized cycle count is reached or early completion is selected.

In some embodiments, after each door-closed condition, the controller increments the usage-cycle counter and updates a remaining-cycles display. When the authorized cycle count is reached, the controller locks the door, stores a completion record, and finalizes payment capture (immediately or via queued capture if connectivity is lost after authorization).

### Alternative Embodiments and Variations

In some embodiments, the kiosk may be deployed with different receiving bin sizes, door mechanisms, sensor suites, and communication interfaces, and the multi-cycle authorization concept remains applicable. In some embodiments, pricing tiers may map to different authorized cycle counts, different maximum total weight, different time windows, or combinations thereof.

### Non-transitory Computer-readable Storage Media

The PLC firmware, HMI software, and cloud-based applications are stored on non-transitory computer-readable storage media. For the PLC, this includes flash memory or EEPROM storing the control program and configuration data. For cloud services, this includes solid-state drives (SSDs) or hard disk drives (HDDs) in server infrastructure. For mobile and web applications, this includes storage on user devices or cached in browser memory.

The instructions stored on these media, when executed by processors (PLC processors, server CPUs, mobile device processors), cause the processors to perform the operations described herein, including state-based control logic, payment processing, sensor monitoring, actuator control, diagnostic routines, data logging, analytics processing, and user interface presentation.

### Conclusion

The cloud-integrated autonomous waste compaction system disclosed herein represents a significant advancement over prior art by integrating payment authorization, electronically controlled access, cycle-based usage tracking, automated compaction control, comprehensive sensor monitoring, and cloud-based remote operation into a unified system enabling autonomous operation without on-site personnel. The specific technical features, control logic, and system architecture address long-felt needs in the waste management industry and provide advantages not achievable through simple modification or combination of prior art references.

In some embodiments, when the controller grants access it initializes a usage-cycle counter for the transaction session to zero. In some embodiments, for each cycle the controller detects a door-open condition and then detects a subsequent door-closed condition, and the controller increments the usage-cycle counter upon the door-closed condition that follows the door-open condition.

In some embodiments, the system can support different deployment types including stationary compactors with detachable receiver boxes, self-contained mobile compactors, mobile trailers, and truck-mounted units. In some embodiments, power systems may include grid power with backup power and/or battery/solar systems sized for autonomous operation.

While preferred embodiments of the present system/apparatus have been shown and described herein, it will be obvious to those skilled in the art that such embodiments are provided by way of example only. Numerous variations, changes, and substitutions will now occur to those skilled in the art without departing from the system/apparatus. It should be understood that various alternatives to the embodiments of the system/apparatus described herein may be employed in practicing the system/apparatus. It is intended that the following claims define the scope of the system/apparatus and that methods and structures within the scope of these claims and their equivalents be covered thereby.

What is claimed is:

1. An autonomous commercial waste compaction system comprising:
a commercial waste compactor having a compaction chamber, a hydraulic ram actuator, and a detachable receiver box configured to receive compacted waste;
a control enclosure housing a programmable logic controller (PLC) configured to execute state-based control logic;
a payment kiosk integrated with the control enclosure and comprising at least two payment acceptance devices selected from the group consisting of: credit card readers, debit card readers, near-field communication (NFC) contactless readers, biometric scanners, QR code readers, and token acceptors;
a sized receiving bin with an automated access door configured to receive waste materials from users;
an electronic door lock actuator electrically connected to the PLC and configured to selectively engage and disengage a locking mechanism securing the automated access door;
a door position sensor electrically connected to the PLC and configured to detect open and closed states of the automated access door;
a cycle counter implemented in the PLC and configured to increment upon detection of door closure by the door position sensor;
a capacity monitoring system comprising at least one sensor selected from the group consisting of: fill level sensors, weight sensors, and hydraulic pressure sensors, said capacity monitoring system configured to detect fill status of the compaction chamber;
a multi-protocol communication system comprising at least two communication interfaces selected from the group consisting of: WiFi transceivers, Ethernet interfaces, cellular modems, and radio transceivers, said communication system configured to establish bidirectional communication with remote cloud services via wide area networks; wherein the PLC executes state-based control logic to:
(i) maintain the electronic door lock actuator in an engaged state preventing door opening until receiving a payment authorization signal from the payment kiosk;
(ii) responsive to receiving the payment authorization signal, command the electronic door lock actuator to disengage the locking mechanism and store an authorized cycle count value in PLC memory;
(iii) monitor the door position sensor and responsive to detecting door closing, increment the cycle counter;
(iv) compare a value of the cycle counter to the authorized cycle count value and responsive to the cycle counter value reaching the authorized cycle count value, command the electronic door lock actuator to re-engage the locking mechanism;
(v) monitor the capacity monitoring system and responsive to detecting that fill status exceeds a compaction trigger threshold, activate the hydraulic ram actuator to perform a compaction cycle; and
(vi) transmit operational data to the remote cloud services via the multi-protocol communication system, said operational data comprising transaction records, cycle counts, fill status measurements, and system diagnostic information.

2. The system of claim 1, wherein the payment kiosk further comprises:
a payment processor configured to communicate with financial networks for real-time transaction authorization; and
wherein receiving the payment authorization signal comprises the payment processor receiving authorization confirmation from a financial network authorizing a payment transaction.

3. The system of claim 1, wherein the sized receiving bin further comprises:
a weight sensor integrated into a door mounting mechanism of the automated access door and configured to measure weight of waste materials deposited into the sized receiving bin;
wherein the PLC is further configured to read weight measurements from the weight sensor upon detecting door closing and store the weight measurements with transaction records.

4. The system of claim 3, wherein the PLC is further configured to:
calculate a transaction cost based on total weight measured across multiple door open/close cycles within a single transaction; and
transmit payment charging instructions to the payment kiosk based on the calculated transaction cost.

5. The system of claim 1, further comprising:
an infrared thermal imaging camera positioned with a field of view encompassing an interior of the sized receiving bin;
wherein the PLC is configured to:
receive thermal image data from the infrared thermal imaging camera;
analyze the thermal image data to detect thermal signatures exceeding a temperature threshold; and
responsive to detecting thermal signatures exceeding the temperature threshold, generate a hazardous material alert transmitted to the remote cloud services.

6. The system of claim 5, wherein the PLC is further configured to:
responsive to detecting thermal signatures exceeding the temperature threshold, prevent subsequent unlocking of the electronic door lock until manual reset by authorized personnel.

7. The system of claim 1, wherein the capacity monitoring system comprises:
a plurality of fill level sensors positioned at different vertical heights within the compaction chamber;
wherein monitoring fill status comprises the PLC determining which fill level sensors detect presence of waste material to calculate a percentage fill level.

8. The system of claim 1, wherein the state-based control logic executed by the PLC defines discrete operational states comprising:
a standby state with the locking mechanism engaged;
a payment authorization state awaiting payment authorization signal;
an access granted state with the locking mechanism disengaged;
a door open state;
a cycle evaluation state following door closing;
a transaction completion state processing final payment; and
a compaction cycle state with the hydraulic ram actuator activated;
wherein the PLC transitions between operational states based on events detected by sensors electrically connected to the PLC.

9. The system of claim 1, further comprising:
a multi-source power management system comprising:
input terminals for grid power connection;
battery charge management circuitry electrically connected to a battery bank;
solar charge controller inputs configured to receive power from photovoltaic panels;
automatic transfer switching circuitry configured to transition between power sources without interrupting operation of the PLC; and
uninterruptible power supply (UPS) circuitry providing continuous power to the PLC during power source transitions.

10. The system of claim 9, wherein the multi-source power management system is configured to:
prioritize grid power when available;
charge the battery bank using solar power during daylight hours when photovoltaic panels generate sufficient power;
supply power to the PLC from the battery bank when grid power is unavailable and solar power is insufficient; and
wherein the system is capable of autonomous operation 24 hours per day, 7 days per week, 365 days per year without external power infrastructure.

11. The system of claim 1, wherein the PLC is further configured to execute diagnostic routines comprising:
polling each sensor electrically connected to the PLC to verify sensor responsiveness;
commanding each actuator electrically connected to the PLC to a test state and verifying state change via sensors;
verifying communication link connectivity to the remote cloud services;
generating a diagnostic report summarizing results of the diagnostic routines; and
transmitting the diagnostic report to the remote cloud services.

12. The system of claim 11, wherein the PLC is configured to execute the diagnostic routines:
following completion of each user transaction; and
periodically at predetermined time intervals during idle periods;
wherein the diagnostic report includes timestamps, sensor readings, fault flags, and pass/fail status for each subsystem.

13. The system of claim 1, wherein the remote cloud services comprise:
a data storage system storing transaction records, sensor data logs, and diagnostic reports uploaded from the PLC;
an analytics processing system configured to analyze stored data and generate operational metrics, capacity predictions, and maintenance recommendations;
a notification generation system configured to generate notifications transmitted to operator devices based on predefined trigger conditions; and
a web application accessible via web browsers providing user interfaces for monitoring system status, viewing analytics, and configuring system parameters.

14. The system of claim 13, wherein the notification generation system is configured to:
compare fill status measurements to a service dispatch threshold;
responsive to fill status exceeding the service dispatch threshold, generate a service dispatch notification transmitted to waste hauling service providers, said notification including GPS location coordinates and estimated time until full capacity.

15. The system of claim 1, wherein the commercial waste compactor is selected from the group consisting of:
a stationary compactor with the detachable receiver box configured for periodic removal and replacement;
a self-contained mobile compactor system with integrated wheels or tracks;
a mobile compactor trailer configured for towing by a vehicle; and
a compactor integrated with a truck chassis.

16. An integrated control cabinet for an automated waste compactor system comprising:
a weather-resistant enclosure configured for outdoor mounting adjacent to a commercial waste compactor;
a programmable logic controller (PLC) housed within the enclosure;
a human-machine interface (HMI) touchscreen mounted on an exterior surface of the enclosure and electrically connected to the PLC;
a payment processing module integrated into the enclosure and comprising:
a payment terminal with a card reader and NFC contactless reader;
a payment processor configured to communicate with financial networks for real-time transaction authorization; and
a receipt printer;
a sensor interface module electrically connected to the PLC and configured to receive inputs from:
at least one video camera;
at least one thermal imaging camera configured to detect elevated temperature signatures;
at least one weight sensor;
at least one hydraulic pressure sensor;
at least one fill level sensor selected from the group consisting of ultrasonic distance sensors, laser rangefinders, and mechanical limit switches;
at least one door position sensor; and
at least one tamper detection sensor selected from the group consisting of vibration sensors and accelerometers;
an actuator control module electrically connected to the PLC and configured to control:
at least one electronic door lock actuator;
at least one hydraulic motor controller for actuating a compactor ram;
indicator lights; and
audible alarm devices;
a multi-source power management system comprising:
input terminals for grid power connection;
battery charge management circuitry;
solar charge controller inputs;
automatic transfer switching configured to transition between power sources without interrupting PLC operation; and
uninterruptible power supply (UPS) circuitry providing ride-through power during power source transitions;
a communication system comprising at least two interfaces selected from the group consisting of:
a WiFi radio;
an Ethernet port;
a cellular modem; and
a long-range radio transceiver;
wherein the PLC is configured to coordinate operations between the HMI, payment processing module, sensor interface module, actuator control module, and communication system to enable autonomous waste compactor operation and transmit real-time operational data to cloud services via the communication system.

17. The integrated control cabinet of claim 16, further comprising:
a local data storage device configured to buffer transaction records, sensor data, and video footage during periods of communication link unavailability;
wherein the PLC is configured to automatically upload buffered data to cloud services upon restoration of communication link connectivity.

18. The integrated control cabinet of claim 16, wherein the enclosure further houses:
operator control interfaces comprising:
owner/operator override controls enabling manual system control by authorized personnel;
emergency stop controls configured to immediately halt all system operations; and
manual movement controls configured to actuate compactor mechanisms for maintenance purposes.

19. The integrated control cabinet of claim 16, wherein the at least one thermal imaging camera comprises:
a first thermal imaging camera with a field of view encompassing a waste receiving bin interior for detecting hazardous materials; and
a second thermal imaging camera with a field of view encompassing a compaction chamber interior for detecting fire conditions.

20. The integrated control cabinet of claim 16, wherein the PLC comprises:
a first processor executing control logic for payment authorization and user access control;
a second processor executing control logic for sensor monitoring and data logging;
a third processor executing control logic for compactor mechanism control and safety interlocks;
wherein the first, second, and third processors communicate via an internal communication bus and coordinate operations to enable autonomous waste compactor operation.

21. A method of autonomously operating a commercial waste compaction system comprising:
providing a commercial waste compactor having a compaction chamber and a hydraulic ram;
integrating a control system with the waste compactor, said control system comprising: a payment authorization device, an electronic door lock actuator controlling access to a receiving bin, a programmable logic controller (PLC), and a communication system configured to transmit data to remote cloud servers;
initializing the PLC to a standby state with the electronic door lock actuator maintaining a door lock in an engaged state;
receiving, by the PLC, a payment authorization signal from the payment authorization device indicating successful payment authorization;
responsive to receiving the payment authorization signal:
commanding, by the PLC, the electronic door lock actuator to disengage the door lock;
storing, by the PLC, an authorized cycle count in PLC memory based on payment amount or payment type;
initializing, by the PLC, a usage cycle counter to zero;
monitoring, by the PLC, a door position sensor;
detecting, by the PLC, door opening followed by door closing based on signals from the door position sensor;
incrementing, by the PLC, the usage cycle counter upon detecting door closing;
comparing, by the PLC, the usage cycle counter to the authorized cycle count;
if the usage cycle counter is less than the authorized cycle count and a transaction completion signal has not been received:
maintaining, by the PLC, the door lock in a disengaged state to permit additional disposal cycles;
if the usage cycle counter equals the authorized cycle count or a transaction completion signal is received:
commanding, by the PLC, the electronic door lock actuator to engage the door lock;
processing, by the PLC, a final payment transaction;
executing, by the PLC, diagnostic routines to verify operational status; and
transmitting, by the communication system, transaction data and diagnostic data to the remote cloud servers;
monitoring, by the PLC, fill level sensors in the compaction chamber independently of user transaction status;
responsive to detecting that fill level exceeds a compaction trigger threshold, activating, by the PLC, the hydraulic ram to perform a compaction cycle; and
returning to the standby state with the door lock engaged.

22. The method of claim 21, further comprising:
reading, by the PLC, weight measurements from a weight sensor integrated into the receiving bin upon detecting each door closing event;
accumulating, by the PLC, total weight deposited across multiple disposal cycles within a single transaction;
calculating, by the PLC, a transaction cost based on the accumulated total weight and a per-unit-weight pricing rate; and
processing the final payment transaction based on the calculated transaction cost.

23. The method of claim 21, further comprising:
receiving, by the PLC, thermal image data from an infrared thermal imaging camera positioned to view contents of the receiving bin;
analyzing, by the PLC, the thermal image data to identify thermal signatures exceeding a temperature threshold indicating potential hazardous materials or fire hazards;
responsive to identifying thermal signatures exceeding the temperature threshold:
generating, by the PLC, a hazardous material alert;
transmitting, by the communication system, the hazardous material alert to the remote cloud servers; and
preventing, by the PLC, subsequent door unlocking until manual reset by authorized personnel.

24. The method of claim 21, wherein executing diagnostic routines comprises:
polling, by the PLC, each sensor connected to the PLC to verify sensor responsiveness;
commanding, by the PLC, each actuator connected to the PLC to a test state and verifying state change via sensors;
checking, by the PLC, communication link status by transmitting a heartbeat message to the remote cloud servers and awaiting acknowledgment;
monitoring, by the PLC, power supply voltage levels;
generating, by the PLC, a diagnostic report comprising pass/fail status for each subsystem, sensor readings, fault flags, and timestamp; and
transmitting, by the communication system, the diagnostic report to the remote cloud servers.

25. The method of claim 21, wherein the method enables autonomous operation of the waste compaction system 24 hours per day, 7 days per week, 365 days per year without requiring on-site human operators.

26. The method of claim 21, wherein activating the hydraulic ram to perform a compaction cycle comprises:
commanding, by the PLC, a hydraulic motor controller to activate a hydraulic pump;
extending, by hydraulic pressure, the hydraulic ram into the compaction chamber to compress accumulated waste;
monitoring, by the PLC, hydraulic pressure sensors to detect compaction completion when pressure exceeds a completion threshold;
commanding, by the PLC, the hydraulic motor controller to retract the hydraulic ram to a home position;
re-evaluating, by the PLC, the fill level sensors to determine updated fill status;
if updated fill status is below the compaction trigger threshold, re-enabling, by the PLC, customer access functionality; and
if updated fill status remains above a receiver box full threshold:
entering, by the PLC, an out-of-service state;
displaying, by a user interface, a message indicating the system is unavailable;
transmitting, by the communication system, a service dispatch notification to the remote cloud servers; and
maintaining the door lock in the engaged state until service personnel empty a receiver box and reset the system.

27. Non-transitory computer-readable storage media encoded with instructions executable by a programmable logic controller (PLC) to operate an autonomous waste compaction system, the instructions comprising:
instructions to maintain a door lock actuator in an engaged state and monitor for payment authorization signals from a payment device;
instructions to, responsive to receiving a payment authorization signal:
command the door lock actuator to disengage a door lock;
store an authorized cycle count value in memory;
initialize a usage cycle counter to zero;
instructions to monitor a door position sensor and detect door state transitions between open and closed states;
instructions to, responsive to detecting a door closing event:
increment the usage cycle counter;
compare the usage cycle counter to the authorized cycle count value;
if the usage cycle counter is less than the authorized cycle count value, maintain the door lock actuator in a disengaged state;
if the usage cycle counter equals or exceeds the authorized cycle count value, command the door lock actuator to engage the door lock;
instructions to monitor fill level sensors and hydraulic pressure sensors to determine compaction chamber fill status;
instructions to, responsive to determining that fill status exceeds a compaction trigger threshold:
disable door unlock functionality;
activate a hydraulic motor controller to extend a compactor ram into a compaction chamber;
monitor ram position and hydraulic pressure to detect compaction completion;
upon detecting compaction completion, command retraction of the compactor ram;
re-evaluate fill status;
instructions to capture and store transaction records comprising timestamps, cycle counts, weight measurements, and user identifiers;
instructions to execute diagnostic routines comprising:
polling sensor responsiveness;
verifying actuator functionality;
checking communication link status; and
generating diagnostic reports; and
instructions to transmit operational data including the transaction records, diagnostic reports, and sensor data to remote cloud servers via a communication interface.

28. The storage media of claim 27, wherein the instructions further comprise:
instructions to implement a state machine control algorithm defining operational states comprising:
a standby state;
a payment authorization state;
an access granted state;
a door open state;
a cycle evaluation state;
a transaction completion state;
a compaction cycle state; and
a diagnostic state;
and defining state transitions based on events detected by sensors electrically connected to the PLC.

29. The storage media of claim 27, wherein the instructions to execute diagnostic routines further comprise:
instructions to compare sensor readings to expected value ranges and flag sensors providing readings outside expected ranges;
instructions to compare actuator response times to expected response time ranges and flag actuators with response times outside expected ranges;
instructions to track cumulative cycle counts for actuators and flag actuators approaching maintenance cycle thresholds;
instructions to analyze hydraulic pressure patterns over time and flag anomalies indicating hydraulic system degradation; and
instructions to generate predictive maintenance recommendations based on flagged components and transmit the recommendations to the remote cloud servers.

30. The storage media of claim 27, wherein the instructions further comprise:
instructions to receive configuration data from the remote cloud servers, said configuration data comprising:
pricing parameters defining cost per cycle, cost per unit weight, or tiered pricing structures;
authorized cycle count values corresponding to different payment amounts;
compaction trigger threshold values;
diagnostic routine execution frequency;
notification trigger conditions and notification recipient addresses;
instructions to store the configuration data in non-volatile memory; and
instructions to apply the configuration data to operational logic without requiring firmware updates or system restarts.
